(19) United States
(12) Patent Application Publication
(10) Pub. No.: US 2024/0281401 A1
(43) Pub. Date: Aug. 22, 2024

(54) ADDRESS ASSIGNMENT FOR DEVICES COUPLED TO A SHARED BUS

(71) Applicant: QUALCOMM Incorporated, San Diego, CA (US)

(72) Inventors: Lalan Jee MISHRA, Escondido, CA (US); Richard Dominic WIETFELDT, San Diego, CA (US); Umesh SRIKANTIAH, San Diego, CA (US); Francesco GATTA, San Diego, CA (US); Christopher Kong Yee CHUN, Austin, TX (US)

(21) Appl. No.: 18/171,264

(22) Filed: Feb. 17, 2023

(51) Int. Cl. G06F 13/42; G06F 13/40

(52) U.S. Cl. CPC G06F 13/4282; G06F 13/4022; G06F 2213/0018

(57) ABSTRACT

A subordinate device participates in address assignment through iterative communication with a host device. The subordinate device receives a first broadcast command over a multidrop serial bus, decouples a daisy chain input of the subordinate device from a daisy chain output of the subordinate device, receives a second broadcast command over the multidrop serial bus, responds to the second broadcast command when a signal received through the daisy chain input is in an active state, ignores the second broadcast command when the signal received through the daisy chain input is in an inactive state, and ignores subsequent broadcast commands after responding to the second broadcast command. Responding to the second broadcast command includes configuring a unique device identifier of the subordinate device using an address provided in the second broadcast command, and coupling the daisy chain input of the subordinate device to the daisy chain output of the subordinate device.

### TECHNICAL FIELD

The present disclosure relates generally to serial communication and more particularly to addressing devices coupled to the serial bus with predefined initial device addresses.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a multidrop serial bus or a parallel bus. General-purpose serial interfaces known in the industry include the Inter-Integrated Circuit (I2C or I²C) serial interface and its derivatives and alternatives.

The Mobile Industry Processor Interface (MIPI) Alliance defines standards and protocols for the Improved Inter-Integrated Circuit (I3C) serial interface, the Radio Frequency Front-End (RFFE) interface, the system power management interface (SPMI) and other interfaces. These interfaces may be used to connect processors, sensors and other peripherals, for example. In some interfaces, multiple host devices are coupled to the serial bus such that two or more devices can serve as host device for different types of messages transmitted on the serial bus. The RFFE interface defines a communication interface that can be for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communication device, multiple antennas and radio transceivers may support multiple concurrent RF links. In another example, SPMI specifications defined by the MIPI Alliance provide a hardware interface that may be implemented between baseband or application processors and peripheral components. In some implementations, the SPMI is deployed to support power management operations within a device.

As device complexity increases, demand for increased device density also increases and there is demand for improved address management for standardized bus architectures and protocols.

### SUMMARY

Certain aspects of the disclosure relate to systems, apparatus, methods and techniques that can dynamically configure device addresses without regard to the potential for duplicate device addresses appearing on a multidrop serial bus after initial system initialization or power on.

In various aspects of the disclosure, a method of data communication at a subordinate device, includes receiving a first broadcast command over a multidrop serial bus, decoupling a daisy chain input of the subordinate device from a daisy chain output of the subordinate device, receiving a second broadcast command over the multidrop serial bus, responding to the second broadcast command when a signal received through the daisy chain input is in an active state, ignoring the second broadcast command when the signal received through the daisy chain input is in an inactive state, and ignoring subsequent broadcast commands after responding to the second broadcast command. Responding to the second broadcast command may include configuring a unique device identifier of the subordinate device using an address provided in the second broadcast command, and coupling the daisy chain input of the subordinate device to the daisy chain output of the subordinate device.

In various aspects of the disclosure, a subordinate device is implemented with an interface circuit adapted to couple the subordinate device to a multidrop serial bus and a controller. The controller may be configured to receive a first broadcast command over the multidrop serial bus, decouple a daisy chain input of the subordinate device from a daisy chain output of the subordinate device, receive a second broadcast command over the multidrop serial bus, respond to the second broadcast command when a signal received through the daisy chain input is in an active state by configuring a unique device identifier of the subordinate device using an address provided in the second broadcast command, and coupling the daisy chain input of the subordinate device to the daisy chain output of the subordinate device, and ignore subsequent broadcast commands after responding to the second broadcast command.

In various aspects of the disclosure, method of data communication at a host device, includes transmitting a first broadcast command over a first multidrop serial bus, the first broadcast command being configured to cause a daisy chain input of a first subordinate device to be decoupled from a daisy chain output of the first subordinate device, and for each subordinate device in a plurality of subordinate devices coupled to the first multidrop serial bus, cause a daisy chain input of the each subordinate device to be decoupled from a daisy chain output of the each subordinate device, the daisy chain input of the each subordinate device being coupled to the daisy chain output of another subordinate device. The method further includes activating a program enable signal that is coupled to the daisy chain input of the first subordinate device, and broadcasting a first sequence of address configuration commands over the first multidrop serial bus. Each subordinate device is configured to respond to a first address configuration command received after detecting the activated program enable signal at its daisy chain input. Each subordinate device is further configured to ignore subsequent address configuration commands. Each address configuration command is configured to configure a unique device identifier in a subordinate device that responds to the each address configuration command, and cause the daisy chain input of the subordinate device that responds to the each address configuration command to be coupled to the daisy chain output of the subordinate device that responds to the each address configuration command.

In various aspects of the disclosure, a data communication apparatus has an interface circuit adapted to couple the data communication apparatus to one or more multidrop serial buses, and a controller. The controller is configured to transmit a first broadcast command over a first multidrop serial bus, the first broadcast command being configured to cause a daisy chain input of a first subordinate device to be decoupled from a daisy chain output of the first subordinate device, and for each subordinate device in a plurality of subordinate devices coupled to the first multidrop serial bus, cause a daisy chain input of the each subordinate device to be decoupled from a daisy chain output of the each subordinate device, the daisy chain input of the each subordinate device being coupled to the daisy chain output of another subordinate device. The controller is configured to activate a program enable signal that is coupled to the daisy chain input of the first subordinate device and broadcast a first sequence of address configuration commands over the first multidrop serial bus. Each subordinate device may be configured to respond to a first address configuration command received after detecting the activated program enable signal at its daisy chain input. Each subordinate device is further configured to ignore subsequent address configuration commands. Each address configuration command is configured to configure a unique device identifier in a subordinate device that responds to the each address configuration command, and cause the daisy chain input of the subordinate device that responds to the each address configuration command to be coupled to the daisy chain output of the subordinate device that responds to the each address configuration command.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates certain aspects of a 2-dataline serial peripheral interface that may be adapted according to certain aspects disclosed herein.

FIG. 4 illustrates a device configuration for coupling various radio frequency front-end devices using multiple RFFE buses.

FIG. 5 illustrates a system in which one-wire subordinate devices and two-wire subordinate devices coexist in accordance with certain aspects disclosed herein.

FIG. 6 illustrates an example of hardware configurable device addresses in a peripheral device coupled to a multidrop serial bus.

FIG. 7 illustrates a subordinate device that has been configured to support dynamic address configuration in accordance with certain aspects of this disclosure.

FIG. 8 illustrates a first example of a system that is configured to support dynamic address configuration in accordance with certain aspects of this disclosure.

FIG. 9 illustrates a second example of a system that is configured to support dynamic address configuration in accordance with certain aspects of this disclosure.

FIG. 10 illustrates a third example of a system that is configured to support dynamic address configuration in accordance with certain aspects of this disclosure.

FIG. 11 illustrates a fourth example of a system that is configured to support dynamic address configuration in accordance with certain aspects of this disclosure.

FIG. 12 illustrates a fifth example of a system that is configured to support dynamic address configuration in accordance with certain aspects of this disclosure.

FIG. 13 illustrates one example of an apparatus employing a processing circuit that may be adapted according to certain aspects disclosed herein.

FIG. 14 is a flowchart that illustrates a method performed at a subordinate device coupled to a multidrop serial bus in accordance with certain aspects disclosed herein.

FIG. 15 illustrates a hardware implementation of a subordinate device coupled to a multidrop serial bus in accordance with certain aspects disclosed herein.

FIG. 16 is a flowchart that illustrates a method performed at a host device coupled to a multidrop serial bus in accordance with certain aspects disclosed herein.

FIG. 17 illustrates a hardware implementation of a host device coupled to a multidrop serial bus in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Certain aspects of the disclosure relate to serial bus configurations in which multiple devices can communicate at various times. The described serial buses are typically operated in a hierarchical manner, in that one device controls communication during a transaction. The controlling device may be referred to as a host device, a bus master device, a managing device or another term favored by standards defining the protocols implemented by the controlling device. In some serial bus configurations, a single controlling device manages or controls communication during all transactions conducted over the serial bus. In other serial bus configurations, multiple devices can operate as the controlling device and one device serves as the controlling device for each transaction conducted over the serial bus. The controlling device may provide a common clock signal that is transmitted over a conventional two-wire serial bus. The controlling device may provide control signaling that identifies a type of transaction to be conducted over a conventional two-wire serial bus. During certain transactions, a controlling device may transmit commands directed to one or more receiving devices using address information provided in or with the commands. The receiving devices may be referred to as a subordinate device, a client device, a slave device, a peripheral device or another term favored by standards defining the protocols implemented by the controlling device. For the purposes of this disclosure, a controlling device will be referred to as a host device and associated receiving devices will be referred to as subordinate devices.

### Overview

Devices that include multiple SoC and other IC devices often employ a shared communication interface that may include a serial bus or other data communication link used to connect processors with modems and other peripherals. The serial bus or other data communication link may be operated in accordance with one or more standards or protocols defined. For example, the serial bus may be operated in accordance with an I2C, I3C, SPMI, and/or RFFE protocol, or another protocol that may be configured for half-duplex operation. Increased functionality and complexity of operations can result in increased numbers of devices coupled to serial buses, including multiple instances of the same type of device. Certain types of device are preprogrammed with the same device identifier that is intended to identify the device when communicating over the serial bus. Some devices are programmed with a small number of device identifiers that can be selected using hardware strapping provided externally of the device. The limited availability of device identifiers can restrict the functionality of systems and/or can force the use of multiple serial buses.

Certain aspects of this disclosure relate to systems, circuits and procedures that enable the configuration of device identifiers, including when a device has no preassigned device identifier or when multiple devices are preconfigured with the same device identifier. In one example, a method of data communication at a subordinate device includes receiving a first broadcast command over a multidrop serial bus, decoupling a daisy chain input of the subordinate device from a daisy chain output of the subordinate device, receiving a second broadcast command over the multidrop serial bus, responding to the second broadcast command when a signal received through the daisy chain input is in an active state, ignoring the second broadcast command when the signal received through the daisy chain input is in an inactive state, and ignoring subsequent broadcast commands after responding to the second broadcast command. Responding to the second broadcast command may include configuring a unique device identifier of the subordinate device using an address provided in the second broadcast command, and coupling the daisy chain input of the subordinate device to the daisy chain output of the subordinate device.

Certain aspects disclosed herein may be applicable to a serial bus operated in accordance with standardized protocols such as I2C, I3C, SPMI, RFFE and/or serial peripheral interface (SPI) protocols. Certain aspects are applicable to a serial bus operated in half-duplex mode or full-duplex mode. Certain aspects are applicable to multipoint interfaces and/or interfaces operated in point-to-point mode.

Examples of Apparatus that Employ Serial Data Links

According to certain aspects of this disclosure, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

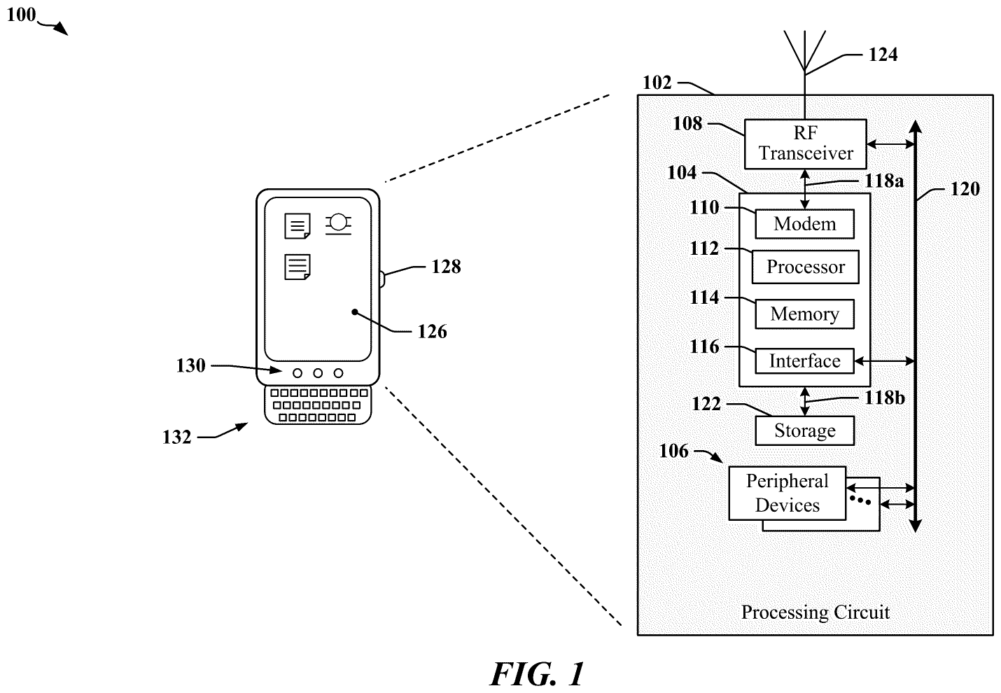

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

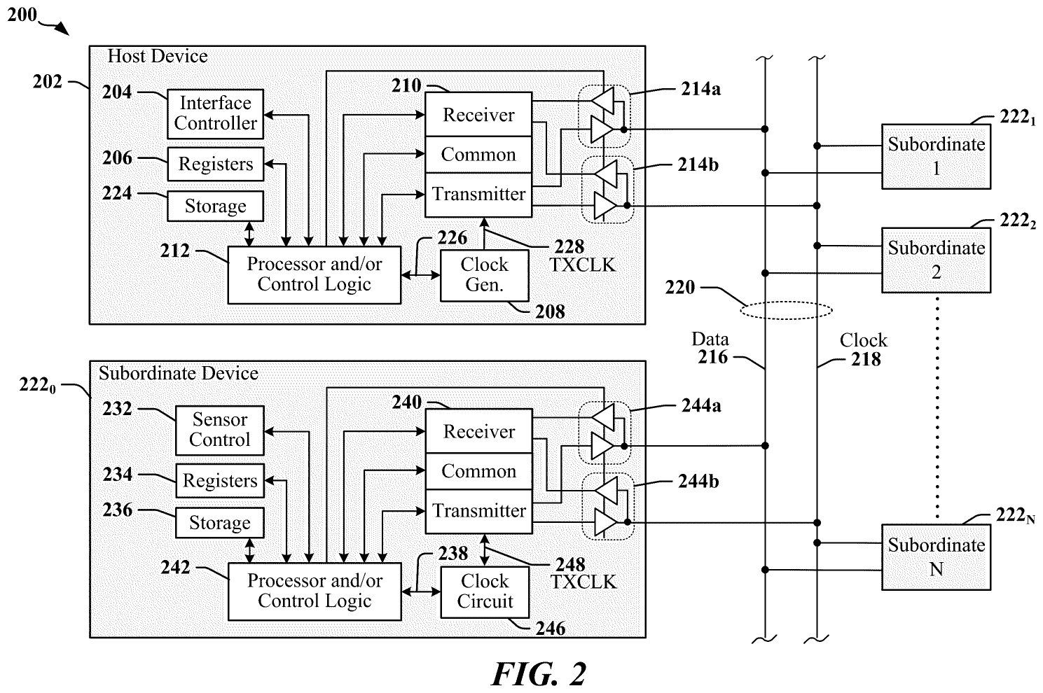

FIG. 2 illustrates certain aspects of an apparatus 200 that includes multiple devices 202, and 222₀-222_{N} coupled to a serial bus 220. The devices 202 and 222₀-222_{N} may be implemented in one or more semiconductor IC devices, such as an applications processor, SoC or ASIC. In various implementations the devices 202 and 222₀-222_{N} may include, support or operate as a modem, a signal processing device, a display driver, a camera, a user interface, a sensor, a sensor controller, a media player, a transceiver, RFFE devices and/or other such components or devices. In some examples, one or more of the subordinate devices 222₀-222_{N} may be used to control, manage or monitor a sensor device. Communication between devices 202 and 222₀-222_{N} over the serial bus 220 is controlled by a master device 202. Certain types of bus can support multiple master devices 202.

In one example, a master device 202 may include an interface controller 204 that manages access to the serial bus, configures dynamic addresses for subordinate devices 222₀-222^{N} and/or causes a clock signal 228 to be transmitted on a clock line 218 of the serial bus 220. The master device 202 may include configuration registers 206 or other storage 224, and other control logic 212 configured to handle protocols and/or higher-level functions. The control logic 212 may include a processing circuit such as a state machine, sequencer, signal processor or general-purpose processor. The master device 202 includes a transceiver 210 and line drivers/receivers 214a and 214b. The transceiver 210 may include receiver, transmitter and common circuits, where the common circuits may include timing, logic and storage circuits and/or devices. In one example, the transmitter encodes and transmits data based on timing in the clock signal 228 provided by a clock generation circuit 208. Other timing clocks 226 may be used by the control logic 212 and other functions, circuits or modules.

At least one device 222₀-222_{N} may be configured to operate as a subordinate device on the serial bus 220 and may include circuits and modules that support a display, an image sensor, and/or circuits and modules that control and communicate with one or more sensors that measure environmental conditions. In one example, a subordinate device 222₀ configured to operate as a subordinate device may provide a control function, module or circuit 232 that includes circuits and modules to support a display, an image sensor, and/or circuits and modules that control and communicate with one or more sensors that measure environmental conditions. The subordinate device 222₀ may include configuration registers 234 or other storage 236, control logic 242, a transceiver 240 and line drivers/receivers 244a and 244b. The control logic 242 may include a processing circuit such as a state machine, sequencer, signal processor or general-purpose processor. The transceiver 210 may include receiver, transmitter and common circuits, where the common circuits may include timing, logic and storage circuits and/or devices. In one example, the transmitter encodes and transmits data based on timing in a clock signal 248 provided by clock generation and/or recovery circuits 246. The clock signal 248 may be derived from a signal received from the clock line 218. Other timing clocks 238 may be used by the control logic 242 and other functions, circuits or modules.

The serial bus 220 may be operated in accordance with RFFE, I2C, I3C, SPMI, or another protocol. At least one device 202, 222₀-222_{N} may be configured to selectively operate as either a master device or a subordinate device on the serial bus 220. Two or more devices 202, 222₀-222_{N} may be configurable to operate as a master device on the serial bus 220.

In some implementations, the serial bus 220 may be operated in accordance with an I3C protocol. Devices that communicate using the I3C protocol can coexist on the same serial bus 220 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the two-wire serial bus 220, in addition to data formats and aspects of bus control. In some aspects, the I2C and I3C protocols may define direct current (DC) characteristics affecting certain signal levels associated with the serial bus 220, and/or alternating current (AC) characteristics affecting certain timing aspects of signals transmitted on the serial bus 220. In some examples, a two-wire serial bus 220 transmits data on a data line 216 and a clock signal on the clock line 218. In some instances, data may be encoded in the signaling state, or transitions in signaling state of the data line 216 and the clock line 218.

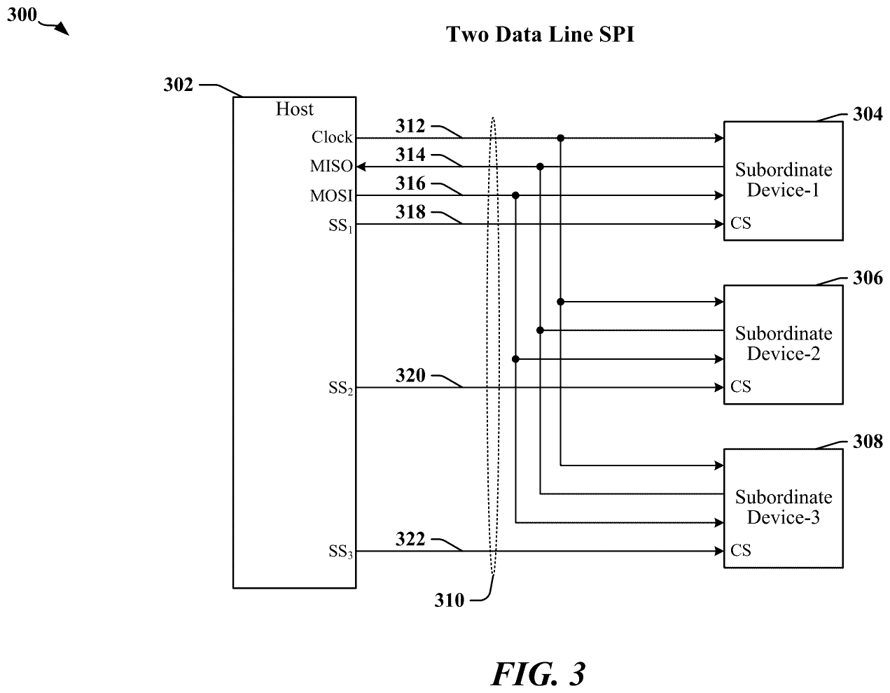

In accordance with certain aspects of this disclosure, a serial bus operated in accordance with serial peripheral interface (SPI) protocols can be used to provide a simple, low-power communication interface. In one example, the SPI interface may be used primarily to exchange data between a processing circuit and a touch panel of a display. An SPI interface may be coupled to a serial bus that has a clock wire, two data lines (Master In Slave Out (MISO) line, Master Out Slave In (MOSI) line) and a Chip Select (CS) for each subordinate device. The presence of MISO and MOSI lines enables full-duplex operation. FIG. 3 illustrates certain aspects related to the operation a two data line SPI 300. In some instances, a master device 302 may be incorporated in an SoC that serves as an application processor, host processor, or other functional component of an apparatus or system. The master device 302 is coupled to multiple subordinate devices 304, 306, 308 using a multi-wire bus 310. The master device 302 drives data to the subordinate devices 304, 306, 308 over a master-out-slave-in line (MOSI line 316) of the multi-wire bus 310. The subordinate devices 304, 306, 308 may each drive data to the master device 302 over a shared master-in-slave-out line (MISO line 314) of the multi-wire bus 310.

The multi-wire bus 310 includes at least one slave select line 318, 320, 322 for each subordinate device 304, 306, 308. As illustrated, a first slave select line 318 (SS1) controls bus access by the first subordinate device 304, a second slave select line 320 (SS2) controls bus access by the second subordinate device 306, and a third slave select line 322 (SS3) controls bus access by the third subordinate device 304. The master device 302 may assert a slave select line 318, 320, 322 to cause a corresponding subordinate device 304, 306, 308 to receive data over the MOSI line 316, and/or to grant permission to the corresponding subordinate device 304, 306, 308 to transmit on the MISO line 314.

In one example, the slave select lines 318, 320, 322 are not asserted when a low voltage level is applied to the slave select lines 318, 320, 322, and a slave select line 318, 320, 322 is asserted by driving the slave select line 318, 320, 322 to a high voltage level (e.g., towards the power supply level). In another example, the slave select lines 318, 320, 322 are not asserted when a high voltage level (e.g., the power supply level) is applied to the slave select lines 318, 320, 322, and a slave select line 318, 320, 322 is asserted by driving the slave select line 318, 320, 322 to a low voltage level. For each slave select line 318, 320, 322, a driver in the master device 302 may be operated to charge and discharge the slave select line 318, 320, 322 based on assertion state desired for the slave select line 318, 320, 322.

Data is transmitted between the master device 302 and a subordinate device 304, 306, 308 in accordance with a clock signal provided on a clock line 312 of the multi-wire bus 310. Data signaling is unidirectional on the MISO line 314 and on the MOSI line 316. Data is transferred over the MISO line 314 in a direction opposite to that of data transferred over the MOSI line 316. Data transfers over the MISO line 314 and MOSI line 316 are synchronized to the clock signal provided on the clock line 312.

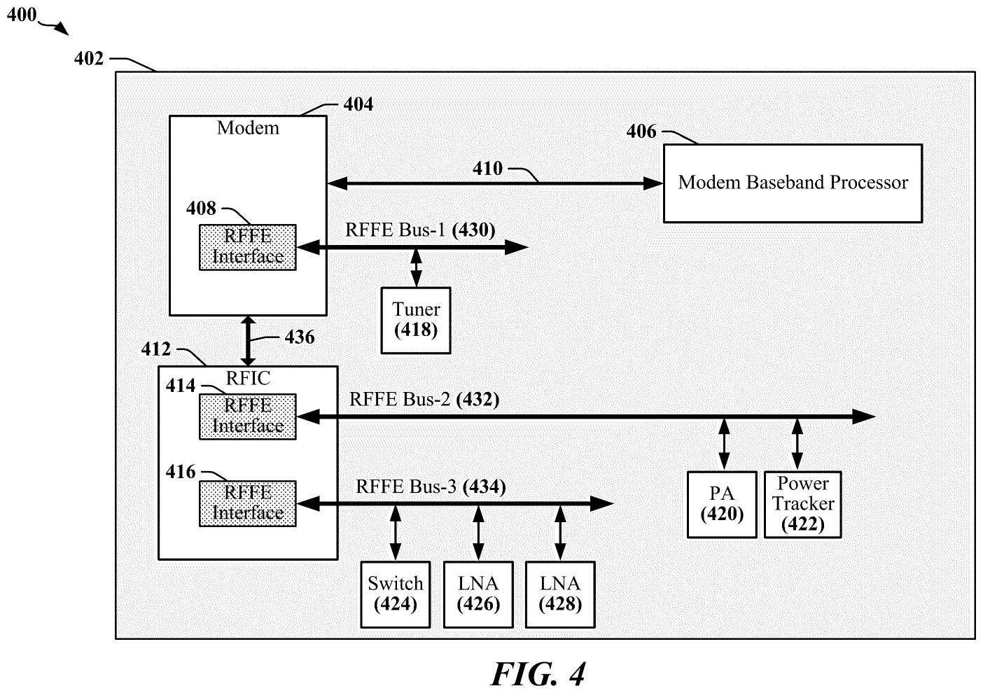

FIG. 4 is a diagram 400 illustrating an example of a configuration of communication links in a chipset or device 402 that employs multiple RFFE buses 430, 432, 434 to couple various RF front-end devices 418, 420, 422, 424, 426 428. In this example, a modem 404 includes an RFFE interface 408 that couples the modem 404 to a first RFFE bus 430. The modem 404 may communicate with a baseband processor 406 and a Radio-Frequency IC (RFIC 412) through respective communication links 410, 436 or, in some implementations, through a common communication link 410 or 436. The illustrated device 402 may be embodied in one or more of a mobile communication device, a mobile telephone, a mobile computing system, a mobile telephone, a notebook computer, a tablet computing device, a media player, a gaming device, a wearable computing device, a wearable communication device, an appliance, or the like.

In various examples, the chipset or device 402 may be implemented with one or more baseband processors 406, modems 404, RFICs 412, multiple communication links 410, 436, multiple RFFE buses 430, 432, 434 and/or other types of buses. Each of the RFFE buses 430, 432, 434 is managed by a bus owner master (BoM) device. In the example illustrated in FIG. 4, the modem 404 and the RFIC 412 may be designated as BoM for one or more of the RFFE buses 430, 432, 434. The chipset or device 402 may include other processors, circuits, modules and may be configured for various operations and/or different functionalities.

In the example illustrated in FIG. 4, the modem 404 is coupled to an RF tuner 418 through its RFFE interface 408 and the first RFFE bus 430. The RFIC 412 may include one or more RFFE interfaces 414, 416, controllers, state machines and/or processors that configure and control certain aspects of the RF front-end. In the illustrated example, the RFIC 412 communicates with a PA 420 and a power tracking module 422 through a first of its RFFE interfaces 414 and the second RFFE bus 432. In the illustrated example, RFIC 412 communicates with a switch 424 and one or more LNAs 426, 428 through a second of its RFFE interfaces 416 and the third RFFE bus 434.

Bus latency can affect the ability of a serial bus to handle high-priority, real-time and/or other time-constrained messages. Low-latency messages, or messages requiring low bus latency, may relate to sensor status, device-generated real-time events and virtualized GPIO. In one example, bus latency can be measured as the time elapsed between a message becoming available for transmission and the delivery of the message. In another example, bus latency can be measured as the time elapsed between a message becoming available for transmission and commencement of transmission of the message. Other measures of bus latency may be employed. Bus latency typically includes delays incurred while higher priority messages are transmitted, interrupt processing, the time required to terminate a datagram in process on the serial bus, the time to transmit commands causing bus turnaround between transmit mode and receive mode, bus arbitration and/or command transmissions specified by protocol.

In one example, latency-sensitive messages carry or include coexistence messages. Coexistence messages may be transmitted in a multisystem platform to prevent or reduce instances of certain types of RFFE device impinging on each other. RFFE devices that may be the source or subject of coexistence messages include, for example, switches 424, LNAs 426, 428, PAs 420 and other types of device that operate concurrently in a manner that generates inter-device RF interference, and/or that could potentially cause damage to one or more devices. Coexistence management messages may be exchanged between certain devices that are shared between different radio access technologies, wireless subscriptions and/or applications. For example, a switch 424, LNA 426, 428, PA 420 and/or an antenna may be shared by two different radio access technologies which have different transmit and receive schedules, and damage to an LNA 426, 428 or other device may occur if a device begins transmitting using one radio access technology while receiving using another radio access technology. Devices that can interfere with one another may exchange coexistence management (CxM) messages to permit each device to signal imminent actions that may result in interference or conflict. For example, two modems 404 may exchange CxM messages in order to manage the operation of shared components.

In accordance with certain aspects disclosed herein, a two-wire serial bus may be adapted to operate alternately in a conventional two-wire mode and for a one-wire mode. In one example, the serial bus may be operated according to RFFE protocols such that the clock and data line are used for communication with two-wire subordinate devices coupled to the serial bus and the data line is used without a clock signal for communication with one-wire subordinate devices coupled to the serial bus. The host device may use pulse-width modulation to encode data transmitted to one-wire subordinate devices.

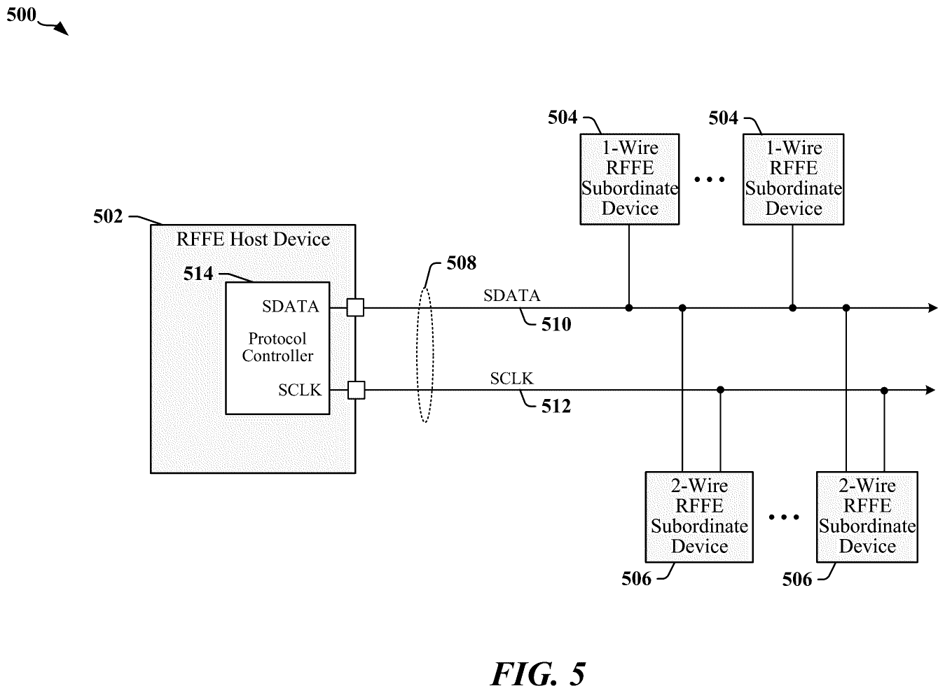

FIG. 5 illustrates a system 500 in which one-wire subordinate devices 504 and two-wire subordinate devices 506 can coexist, and where a host device 502 can communicate with both the one-wire subordinate devices 504 and the two-wire subordinate devices 506 in accordance with certain aspects disclosed herein. The host device 502 may be provided in an RFIC, modem, application processor or another type of device. The host device 502 is coupled to one or more subordinate devices 504, 506 through at least the SDATA line 510 of a two-wire serial bus 508 that also has an SCLK line 512. Data can be encoded in a data signal transmitted over the SDATA line 510 and, in a two-wire mode of communication, a receiver can extract the data using a clock signal transmitted over the SCLK line 512. In the illustrated example, the serial bus 508 is operated in accordance with an RFFE protocol. In other examples, the serial bus 508 may be operated in accordance with another protocol, such as an I3C protocol, SPMI protocol or the like. In the illustrated example, each one-wire subordinate device 504 and each two-wire subordinate device 506 is coupled to the SDATA line 510. The one-wire subordinate devices 504 are adapted for a one-wire mode of communication, while the two-wire subordinate devices 506 are also coupled to the SCLK line 512 to receive the clock signal used in the two-wire mode of communication.

The host device 502 may include a protocol controller 514, which may be implemented by a processing circuit having a processor, controller, state machine or other logic. The protocol controller 514 may be configured to support one or more protocols that can be used to manage operation of the serial bus 508. In some implementations, the protocol controller 514 may be operable to configure one or more subordinate devices 504, 506. The protocol controller 514 may determine a configuration of a subordinate device 504, 506 that is a designated recipient of data to be transmitted over the serial bus 508, and may encode data in a signal to be transmitted over the SDATA line 510 accordingly. In some instances, a broadcast message directed to a combination of one-wire subordinate devices 504 and two-wire subordinate devices 506 may be sent twice, once in the one-wire mode of communication and once in the two-wire mode of communication. The protocol controller 514 may additionally determine whether and/or when a clock signal is to be transmitted over the SCLK line 512. In some implementations, the clock signal is suppressed when data is transmitted in the one-wire mode of communication to one or more one-wire subordinate devices 504.

According to certain aspects disclosed herein, the host device 502 may select between one-wire subordinate devices 504 and two-wire subordinate devices 506 when commencing a transaction. In one example, the host device 502 may use different sequence start conditions (SSCs) to precede one-wire and two-wire transactions. In some implementations, certain interface characteristics of the one-wire subordinate devices 504 and/or two-wire subordinate devices 506 may be configurable. For example, a one-wire subordinate device 504 and/or a two-wire subordinate device 506 coupled to the serial bus 508 may match a specified bus capacitance when driving the SDATA line 510 based on a configurable register setting that defines the capacitance specified for the SDATA line 510. In other instances, the specified bus capacitance can be hard-wired in the one-wire subordinate devices 504 and/or two-wire subordinate devices 506.

The number of active devices that can be coupled to a multidrop serial bus is typically limited by protocol. Certain protocols and standards defined by the MIPI alliance provide an addressing structure in which each subordinate device is assigned a unique device identifier that is expressed as a multibit quantity. In one example, RFFE protocols define a device identifier that has four bits. A unique device identifier may be referred to as the “USID” assigned to an associated device. The BoM for a multidrop serial bus can uniquely identify each device coupled to the multidrop serial bus based on the unique addresses that are assigned to the subordinate/peripheral devices. In conventional implementations, each device is assigned a fixed four-bit USID by design. Certain peripheral devices may be configurable with a number of different USID that can be selected based on a hardware configuration. In one example, a designer desiring to couple multiple instances of a peripheral device to a single multidrop serial bus may use two hardware configurable pins to select between the USID options provided for the peripheral device.

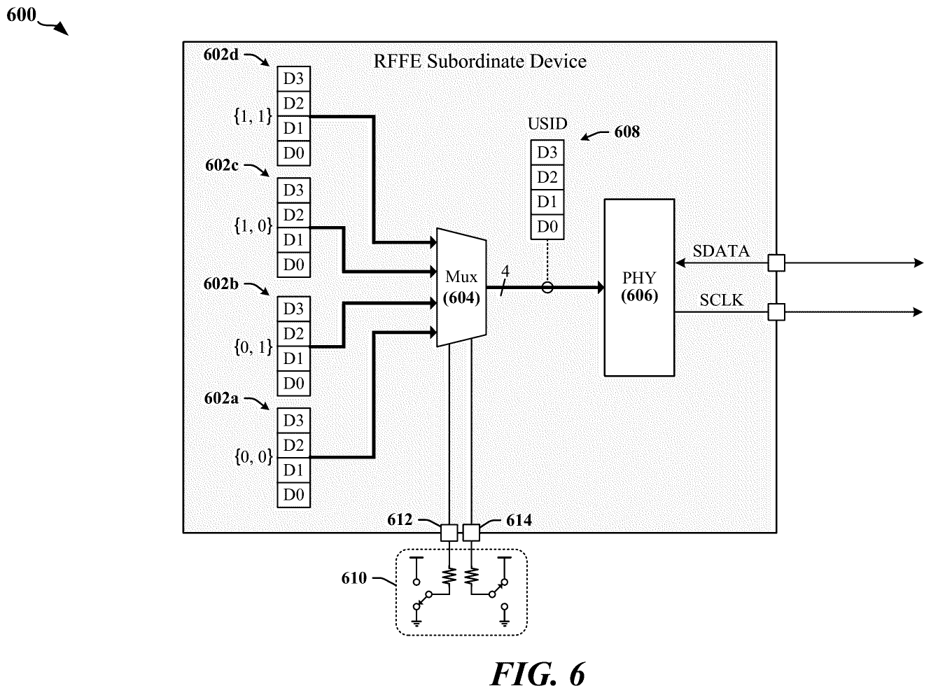

FIG. 6 illustrates an example of hardware configurable USIDs in a peripheral device 600 that is intended to be coupled to a multidrop serial bus operated in accordance with RFFE protocols. A USID 608 is selected to configure the PHY 606 of the peripheral device 600 using external straps that define signaling state of two input/output pins (the I/O pins 612 and 614). In the illustrated example, the signaling state of each of the I/O pins 612, 614 is configured using a switching circuit 610 to select between a pull-up or pull-down mode. The I/O pins 612, 614 are coupled to a multiplexer 604 and provide a two-bit select control input of the multiplexer 604. The switch settings in the switching circuit 610 enable the multiplexer 604 to select between four preprogrammed addresses 602a-602d that are available for the use of the peripheral device 600. In other implementations, the signaling state of the I/O pins 612, 614 is configured by hard wiring the pins to one of two voltage rails, typically through a resistance. The provision of two I/O pins 612, 614 and associated selection circuits increases the cost of manufacturing the peripheral device 600, and increases the complexity of hardware design.

In the example illustrated in FIG. 6, a maximum of four of the peripheral devices 600 can be active on the same multidrop serial bus, since only four preprogrammed addresses 602a-602d are available for use. In some instances, design requirements for a system may specify that more than four of the peripheral devices 600 are to be included in the system, and a second multidrop serial bus may be provided to couple some of the peripheral devices 600 to an SoC, Modem or other host device. These and other issues with hardware configurable USIDs limit the usefulness of the associated devices and increase the complexity of integrating such devices into many systems.

For example, the conventional approach of “pin-strapping” to configure the USID 608 of a peripheral device 600 is cumbersome for 2-wire RFFE subordinate devices 600 and burdensome for 1-wire RFFE subordinate devices 600. One objective of implementing simpler, cost-constrained 1-wire RFFE subordinate devices 600 is to reduce the I/O pin-count needed by the subordinate device 600, and the use of pin-strapping requires the allocation of two additional I/O pins 612, 614 to implement a static function. Both 2-wire and 1-wire RFFE subordinate devices must also include additional resistors to pull-up or pull-down these RF device the I/O pins 612, 614 used to select the USID 608.

According to certain aspects of this disclosure, the USID to be used by a peripheral device for communication over a multidrop serial bus may be dynamically configured by a BoM regardless of whether multiple devices share the same preprogrammed address or whether a device to be configured has no initially assigned address. The multidrop serial bus may be coupled to any number of the same type of peripheral device provided the BoM assigns unique addresses to each peripheral device coupled to the multidrop serial bus. In the example of a multidrop serial bus operated in accordance with RFFE protocols, the addressing and address management schemes disclosed herein can allow a maximum number of 15 peripheral devices to be coupled to the multidrop serial bus when the BoM assigns each peripheral device a unique address. In some implementations, two I/O pins used to select a USID from four or more preprogrammed addresses can be used to support address configuration by the BoM. In other implementations, two I/O pins used for test, fault or other purposes can be used to support address configuration by the BoM.

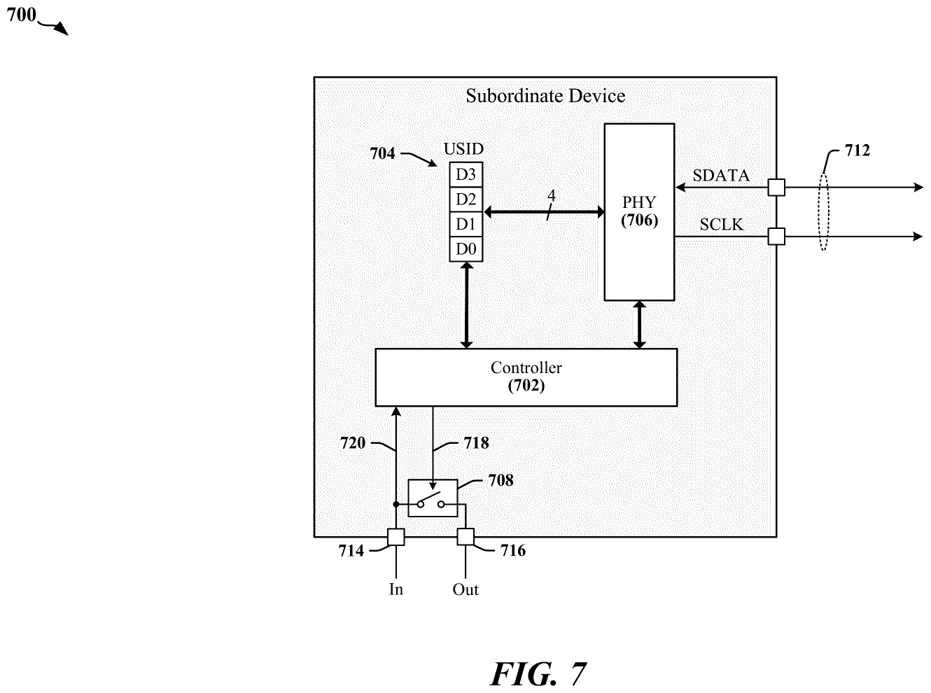

FIG. 7 illustrates a subordinate device 700 that has been configured in accordance with certain aspects of this disclosure to support dynamic address configuration by a BoM. A controller 702 may monitor communication received through physical layer circuits (PHY 706) that are coupled to a multidrop serial bus 712. In this example, the multidrop serial bus 712 is operated in accordance with RFFE protocols. The controller 702 can write the register 704 that holds the USID assigned to the subordinate device 700. The subordinate device 700 is configured to respond to broadcast commands received over the multidrop serial bus and to respond to other types of command that are addressed to the subordinate device 700 using the USID configured for the subordinate device 700.

The controller 702 receives an input signal 720 through an input I/O pin 714. According to an aspect of this disclosure, the input signal 720 can be used to control or indicate dynamic address configuration. The controller 702 provides a control signal 718 that configures a switch 708 during dynamic address configuration. The controller may cause the switch 708 to be opened or closed. When closed, the switch 708 couples the input I/O pin 714 to an output I/O pin 716. The I/O pins 714, 716 enable the subordinate device 700 to be included in a daisy chain of peripheral/subordinate devices that are also coupled to the multidrop serial bus 712. In some examples, the I/O pins 714, 716 may be reconfigured I/O pins, such as the I/O pins 612, 614 in FIG. 6 that provide a two-bit select control input to the multiplexer 604. The input signal 720 may be relayed along the daisy chain when the switch 708 is closed. In some implementations, the input I/O pin 714 is tied to a pull-up or pull-down resistor or circuit within the subordinate device 700 to maintain the input signal 720 in a unasserted state when the input I/O pin 714 is not actively driven by an upstream device.

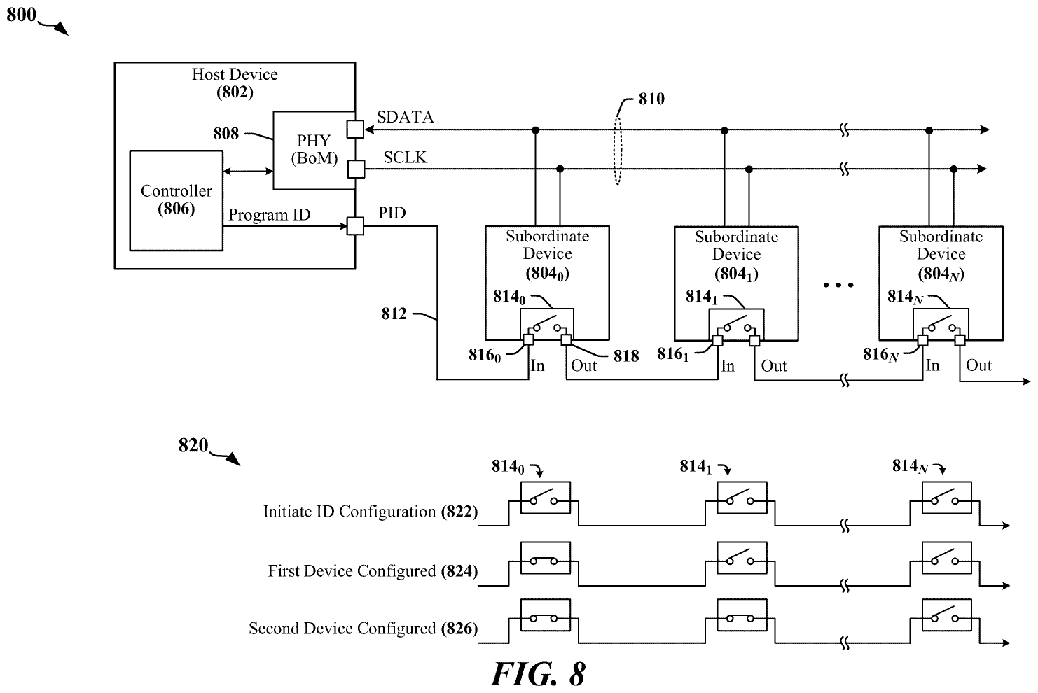

FIG. 8 illustrates a system 800 that includes a multidrop serial bus 810 that couples a host device 802 and multiple subordinate devices 804₀-804_{N} in accordance with certain aspects of this disclosure. The host device 802 is coupled to the multidrop serial bus 810 through physical interface circuits 808 that are configured to operate as a BoM with respect to the multidrop serial bus 810. Each of the subordinate devices 804₀-804_{N} is adapted to support the daisy chain capabilities provided by the subordinate device 700 illustrated in FIG. 7, for example. In some implementations, the multidrop serial bus 810 may be operated in accordance with RFFE protocols.

A controller 806 in the host device 802 is configured to drive a program enable signal (the PID signal 812) through an I/O pin. The PID signal 812 is asserted by the controller 806 during dynamic address configuration. The controller 806 initiates dynamic address configuration by transmitting an initial broadcast command over the multidrop serial bus 810. By protocol, all subordinate devices 804₀-804_{N} coupled to the multidrop serial bus 810 respond to the initial broadcast command without reference to their internal USIDs. The initial broadcast command is a write command that does not require communicative response from any subordinate device 804₀-804_{N}. In general, two or more of the subordinate devices 804₀-804_{N} programmed with the same USID can respond to the initial broadcast command without interfering with one another by, for example, writing an internal register.

According to an aspect of this disclosure, the initial broadcast command causes each of the subordinate devices 804₀-804_{N} to open their respective switches 814₀-814_{N} and to enter a device address configuration mode of operation. In some examples, each subordinate device 804₀-804_{N} may set a flag to indicate that device address configuration is in progress. The controller 806 may configure the USIDs of the subordinate device 804₀-804_{N} by transmitting a series of address configuration commands. Each address configuration command is a broadcast command that is expected to produce a response in one of the subordinate devices 804₀-804_{N}. In some implementations, the controller 806 transmits different USIDs in the address configuration commands and the address configuration commands are transmitted in an order that corresponds to the position of subordinate devices 804₀-804_{N} in the daisy chain. For example, the first address configuration command is configured with the USID for the first subordinate device 804₀ in the daisy chain. The first subordinate device 804₀ receives the PID signal 812 directly from the host device 802. The first address configuration command causes the USID to be written to a register in the first subordinate device 804₀ in the daisy chain.

Each subordinate device 804₀-804_{N} is configured to respond to the next address configuration command transmitted over the multidrop serial bus 810 after it detects that the PID signal 812 is asserted. The subordinate device 804₀-804_{N} may detect assertion of the PID signal 812 by sensing the state of its input I/O pin 816₀-816_{N}. As shown in the first interval 822 in the time sequence 820, the PID signal 812 initially drives only the input I/O pin 816₀ of subordinate devices 804₀ after all switches 814₀-814_{N} have been opened. The USID of subordinate device 804₀ is configured in response to the first address configuration command, which is transmitted during the first interval 822. Upon writing its USID, subordinate device 804₀ closes its switch 814₀ and may set a configuration flag that indicates that its USID has been configured. Subsequent address configuration commands are ignored by subordinate device 804₀ based on the setting of the configuration flag. In some implementations, the switch 814₀ may be configured to switch the input I/O pin 816₀ between an internal sensing circuit or the output pin 818 of subordinate device 804₀. In these latter implementations, the subordinate device 804₀ is no longer coupled to the PID signal 812 after receiving its USID and the input to the sensing device may be pulled by a pull-up or pull-down circuit such that the subordinate device 804₀ effectively senses an unasserted PID signal 812.

The closing of the switch 814₀ in subordinate device 804₀ extends the daisy chain to the next device, which is subordinate device 804₁. Subordinate device 804₁ then senses that the PID signal 812 is asserted and the USID of subordinate device 804₁ is configured in response to the next-transmitted address configuration command, which is transmitted during the second interval 824. Upon writing its USID, subordinate device 804₁ closes its switch 814₁ and may set a configuration flag that indicates that its USID has been configured. Subsequent address configuration commands are ignored by subordinate device 804₁ based on the setting of the configuration flag or the operation of the switch 814₁. Address configuration continues until the USID of the last subordinate device 804_{N} in the daisy chain has been configured during the third illustrated interval 826.

In some implementations, the controller 806 in the host device 802 may cause a broadcast command to be transmitted over the multidrop serial bus 810 in order to cause the subordinate devices 804₀-804_{N} to terminate or exit the device address configuration mode of operation. In some implementations, the host device 802 may interrogate a subordinate device 804₀-804_{N} after configuring its USID. The host device 802 may transmit a read command to cause a subordinate device 804₀-804_{N} to read back its newly configured USID. In some instances, only the most-recently configured subordinate device 804₀-804_{N} processes the read command during address configuration mode of operation and the host device 802 may subsequently transmit a write command to cause the recently configured subordinate device 804₀-804_{N} to close its switch 814₀-814_{N} and/or set the configuration flag that indicates that its USID has been configured.

The presently disclosed dynamic address configuration procedure can be used to assign device addresses for a variety of bus architectures and protocols. The example illustrated in FIG. 8 is described in relation to a the multidrop serial bus 810 that is operated in accordance with RFFE protocols. The concepts and procedures disclosed herein can be implemented using any serial bus architecture that supports broadcasting. The concepts and procedures disclosed herein can be implemented in a 1-wire, 2-wire or other multiwire serial bus architecture. The concepts and procedures disclosed herein can be used to independently assign addresses to 1-wire and 2-wire peripherals that are coupled to the data wire of the same serial bus.

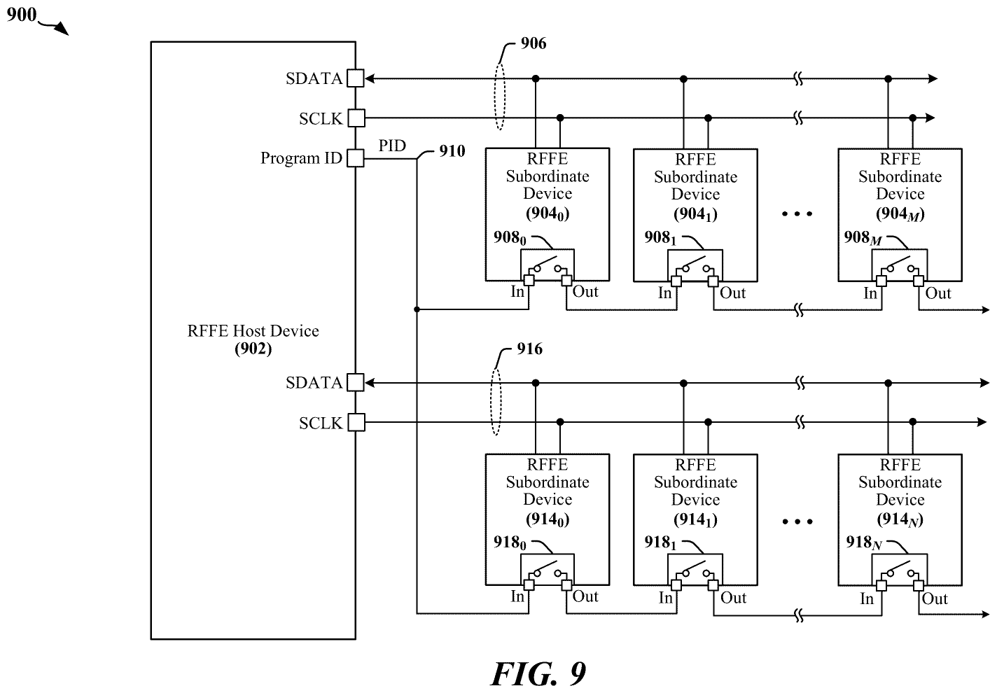

FIG. 9 illustrates a system 900 in which an RFFE host device 902 is the designated or configured BoM for two multidrop serial buses that are operated independently and in accordance with RFFE protocols. In one example, the RFFE host device 902 may correspond to the RFIC 412 illustrated in FIG. 4. The RFFE host device 902 may configure the subordinate devices 904₀-904_{N} coupled to a first multidrop serial bus 906 and the subordinate devices 914₀-914_{N} coupled to a second multidrop serial bus 916. The subordinate devices 904₀-904_{N} coupled to the first multidrop serial bus 906 and the subordinate devices 914₀-914_{N} coupled to the second multidrop serial bus 906 may be configured concurrently or at different times.

The RFFE host device 902 is configured to drive a program enable signal (the PID signal 910) through an I/O pin. The PID signal 910 is asserted by the RFFE host device 902 during dynamic address configuration for either multidrop serial bus 906, 916 or during dynamic address configuration for both multidrop serial buses 906, 916. The RFFE host device 902 initiates dynamic address configuration by transmitting an initial broadcast command over one or both multidrop serial buses 906, 916. By protocol, all subordinate devices 904₀-904_{M}, 914₀-914_{N} are configured to respond to an initial broadcast command without reference to their internal USIDs. The initial broadcast command may be transmitted over any one of the multidrop serial buses 906, 916, or over both multidrop serial buses 906, 916. According to one aspect of this disclosure, the PID signal 910 can be ignored by subordinate devices 904₀-904_{M}, 914₀-914_{N} when an initial broadcast command is not transmitted over the multidrop serial buses 906 or 916 to which they are coupled. For the purposes of this description, an example will be described in which an initial broadcast command is transmitted over both multidrop serial buses 906, 916, either concurrently or within a short period of time such that address configuration procedures for subordinate devices 904₀-904_{M} and 914₀-914_{N} overlap to some extent.

According to an aspect of this disclosure, the initial broadcast commands cause each of the subordinate devices 904₀-904_{M} and 914₀-914_{N} to open their respective switches 908₀-908_{M}, 918₀-918_{N} and to enter a device address configuration mode of operation. In some examples, each subordinate device 904₀-904_{M} and 914₀-914_{N} may set a flag to indicate that device address configuration is in progress. The RFFE host device 902 may configure the USIDs of the subordinate devices 904₀-904_{M} by transmitting a first series of address configuration commands over the first multidrop serial bus 906. The RFFE host device 902 may configure the USIDs of the subordinate devices 914₀-914_{N} by transmitting a second series of address configuration commands over the second multidrop serial bus 916. The first and second series of address configuration commands can be transmitted concurrently or asynchronously with respect to one another.

Each address configuration command transmitted over the first multidrop serial bus 906 is a broadcast command that produces a response in one of the subordinate devices 904₀-904_{M}. Each address configuration command transmitted over the second multidrop serial bus 916 is a broadcast command that produces a response in one of the subordinate devices 914₀-914_{N}. In some implementations, the RFFE host device 902 transmits USIDs in the address configuration commands in an order that corresponds to the position of subordinate devices 904₀-904_{M} or subordinate devices 914₀-914_{N} in their respective daisy chains. In one example, the first address configuration command transmitted over the first multidrop serial bus 906 is configured with the USID for the first subordinate device 904₀ in the first daisy chain, where subordinate device 904₀ receives the PID signal 910 directly from the RFFE host device 902. The first address configuration command transmitted over the first multidrop serial bus 906 causes the USID to be written to a register in the first subordinate device 904₀ in the daisy chain. In another example, the first address configuration command transmitted over the second multidrop serial bus 916 is configured with the USID for the first subordinate device 914₀ in the second daisy chain, where subordinate device 914₀ receives the PID signal 910 directly from the RFFE host device 902. The first address configuration command transmitted over the first multidrop serial bus 906 causes the USID to be written to a register in subordinate device 904₀, and the first address configuration command transmitted over the second multidrop serial bus 916 causes the USID to be written to a register in subordinate device 914₀.

Each subordinate device 904₀-904_{M} and 914₀-914_{N} is configured to respond to the next address configuration command transmitted over its corresponding multidrop serial bus 906, 916 after detecting that the PID signal 910 has been asserted. A subordinate device 904₀-904_{M}, 914₀-914_{N} may detect assertion of the PID signal 910 by sensing the state of an input I/O pin and may then respond to the next received address configuration command. A subordinate device 904₀-904_{M}, 914₀-914_{N} responds to an address configuration command by storing the provided USID and by closing its daisy chain switch 908₀-908_{M}, 918₀-918_{N}. Subsequent address configuration commands are ignored by subordinate devices 904₀-904_{M}, 914₀-914_{N} after their addresses have been configured and based on the setting of a configuration flag or the operation of the corresponding switch 908₀-908_{M}, 918₀-918_{N}.

The closing of the switch 908₀ in subordinate device 904₀ extends the first daisy chain to subordinate device 904₁. Subordinate device 904₁ then senses that the PID signal 910 is asserted and the USID of subordinate device 904₁ is configured in response to the next address configuration command transmitted over the first multidrop serial bus 906. Upon writing its USID, subordinate device 904₁ closes its switch 908₁ and may set a configuration flag that indicates that its USID has been configured. Subsequent address configuration commands are ignored by subordinate device 904₁ based on the setting of the configuration flag or the operation of the switch 908₁. Address configuration continues until the USID of the last subordinate device 904_{M} in the first daisy chain has been configured.

The closing of the switch 918₀ in subordinate device 914₀ extends the second daisy chain to subordinate device 914₁. Subordinate device 914₁ then senses that the PID signal 910 is asserted and the USID of subordinate device 914₁ is configured in response to the next address configuration command transmitted over the second multidrop serial bus 916. Upon writing its USID, subordinate device 914₁ closes its switch 918₁ and may set a configuration flag that indicates that its USID has been configured. Subsequent address configuration commands are ignored by subordinate device 914₁ based on the setting of the configuration flag or the operation of the switch 918₁. Address configuration continues until the USID of the last subordinate device 914_{M} in the first daisy chain has been configured.

Address configuration for the two multidrop serial buses 906, 916 may commence at different times, may proceed at different rates and/or may involve different numbers of subordinate devices 904₀-904_{M} or 914₀-914_{N}. The shared PID signal 910 may be asserted when address configuration is performed on either multidrop serial bus 906, 916. Subordinate devices 904₀-904_{M} or 914₀-914_{N} enter address configuration mode in response to a broadcast command, permitting the RFFE host device 902 to independently operate the multidrop serial buses 906, 916. In one example, the PID signal 910 is asserted when it is in a high signaling state and unasserted when in a low signaling state, where the high signaling state is identifiable by a higher voltage level than the low signaling state. In another example, the PID signal 910 is asserted when it is in a low signaling state and unasserted when in a high signaling state, where the low signaling state is identifiable by a lower voltage level than the high signaling state.

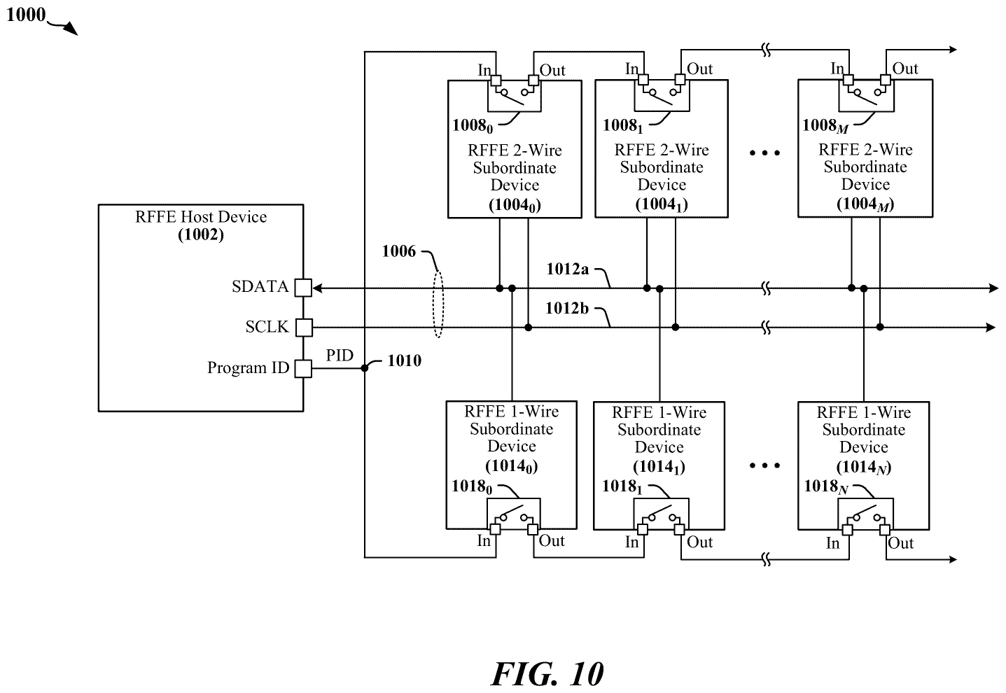

FIG. 10 illustrates a system 1000 in which an RFFE host device 1002 is the designated or configured BoM for a multidrop serial bus that supports 2-wire subordinate devices 1004₀-1004_{N} and one-wire subordinate devices 1014₀-1014_{N} that are operated independently and in accordance with RFFE protocols. In one example, the RFFE host device 1002 may correspond to the RFFE host device 502 illustrated in FIG. 5. The 2-wire subordinate devices 1004₀-1004_{N} and the 1-wire subordinate devices 1014₀-1014_{N} may be configured concurrently or at different times.

The RFFE host device 1002 is configured to drive a program enable signal (the PID signal 1010) through an I/O pin. The PID signal 1010 is asserted by the RFFE host device 1002 during dynamic address configuration of either the 2-wire subordinate devices 1004₀-1004_{N} or the 1-wire subordinate devices 1014₀-1014_{N}. The PID signal 1010 may be asserted by the RFFE host device 1002 during concurrent dynamic address configuration of the 2-wire subordinate devices 1004₀-1004_{N} and the 1-wire subordinate devices 1014₀-1014_{N}. The RFFE host device 1002 initiates dynamic address configuration for 2-wire subordinate devices 1004₀-1004_{N} and by transmitting a 2-wire initial broadcast command over the multidrop serial bus 1006 using SDATA 1012a and SCLK 1012b. The RFFE host device 1002 initiates dynamic address configuration for 1-wire subordinate devices 1004₀-1004_{N} and by transmitting a 1-wire initial broadcast command over the multidrop serial bus 1006 using SDATA 1012a and while suppressing SCLK 1012b. In some implementations, the 1-wire broadcast command is distinguishable from the 2-wire broadcast command by the duration of the SSC timing. The 2-wire subordinate devices 1004₀-1004_{N} ignore 1-wire transmissions when SCLK 1012b is suppressed.

By protocol, all subordinate devices 1004₀-1004_{M}, 1014₀-1014_{N} are configured to respond to an initial broadcast command without reference to their internal USIDs. According to one aspect of this disclosure, the PID signal 1010 is ignored by 2-wire subordinate devices 1004₀-1004_{M} when a 2-wire initial broadcast command has not been transmitted over the multidrop serial bus 1006, and the PID signal 1010 is ignored by 1-wire subordinate devices 1014₀-1014_{N} when a 1-wire initial broadcast command has not been transmitted over the multidrop serial bus 1006. For the purposes of this description, an example will be described in which a 1-wire initial broadcast command and a 2-wire initial broadcast command have been transmitted over the multidrop serial bus 1006 to initiate address configuration.

According to an aspect of this disclosure, the initial broadcast commands cause each of the respective subordinate devices 1004₀-1004_{M} and 1014₀-1014_{N} to open respective switches 1008₀-1008_{M}, 1018₀-1018_{N} and to enter a device address configuration mode of operation. In some examples, each subordinate device 1004₀-1004_{M} and 1014₀-1014_{N} may set a flag to indicate that device address configuration is in progress. The RFFE host device 1002 may configure the USIDs of the 2-wire subordinate device 1004₀-1004_{M} by transmitting a series of 2-wire address configuration commands over the multidrop serial bus 1006. The RFFE host device 1002 may configure the USIDs of the 1-wire subordinate device 1014₀-1014_{N} by transmitting a series of 1-wire address configuration commands over the multidrop serial bus 1006.

Each 2-wire address configuration commands transmitted over the multidrop serial bus 1006 is a broadcast command that produces a response in one of the 2-wire subordinate devices 1004₀-1004_{M}. Each 1-wire address configuration commands transmitted over the multidrop serial bus 1006 is a broadcast command that produces a response in one of the 1-wire subordinate devices 1014₀-1014_{N}. In some implementations, the RFFE host device 1002 transmits USIDs in the address configuration commands in an order that corresponds to the position of subordinate devices subordinate devices 1004₀-1004_{M} or 1014₀-1014_{N} in their respective daisy chains. In one example, the first 2-wire address configuration command transmitted over the multidrop serial bus 1006 is configured with the USID for the first subordinate device 1004₀ in the first daisy chain. Subordinate device 1004₀ receives the PID signal 1010 directly from the RFFE host device 1002. The first 2-wire address configuration command causes the USID to be written to a register in the first subordinate device 1004₀. In another example, the first 1-wire address configuration command transmitted over the multidrop serial bus 1006 is configured with the USID for the first subordinate device 1014₀ in the second daisy chain. Subordinate device 1014₀ receives the PID signal 1010 directly from the RFFE host device 1002. The first 2-wire address configuration command causes a USID to be written to a register in subordinate device 1004₀, and the first 1-wire address configuration command transmitted over the multidrop serial bus 1006 causes a USID to be written to a register in subordinate device 1014₀.

Each subordinate device 1004₀-1004_{M} and 1014₀-1014_{N} is configured to respond to the next cognizable address configuration command transmitted over the multidrop serial bus 1006 after detecting that the PID signal 1010 has been asserted. A subordinate device 1004₀-1004_{M}, 1014₀-1014_{N} may detect assertion of the PID signal 1010 by sensing the state of an input I/O pin and may then respond to the next received address configuration command. A subordinate device 1004₀-1004_{M}, 1014₀-1014_{N} responds to a cognizable address configuration command by storing the provided USID and closing its daisy chain switch 1008₀-1008_{M}, 1018₀-1018_{N}. Subsequent address configuration commands are ignored by subordinate device 804₀ based on the setting of a configuration flag or the operation of the corresponding switch 1008₀-1008_{M}, 1018₀-1018_{N}.

The closing of the switch 1008₀ in subordinate device 1004₀ extends the first daisy chain to subordinate device 1004₁. Subordinate device 1004₁ then senses that the PID signal 1010 is asserted and the USID of subordinate device 1004₁ is configured in response to the next 2-wire address configuration command transmitted over the multidrop serial bus 1006. Upon writing its USID, subordinate device 1004₁ closes its switch 1008₁ and may set a configuration flag that indicates that its USID has been configured. Subsequent address configuration commands are ignored by subordinate device 1004₁ based on the setting of the configuration flag or the operation of the switch 1008₁. Address configuration continues until the USID of the last subordinate device 1004_{M} in the first daisy chain has been configured.

The closing of the switch 1018₀ in subordinate device 1014₀ extends the second daisy chain to subordinate device 1014₁. Subordinate device 1014₁ then senses that the PID signal 1010 is asserted and the USID of subordinate device 1014₁ is configured in response to the next 1-wire address configuration command transmitted over the multidrop serial bus 1006. Upon writing its USID, subordinate device 1014₁ closes its switch 1018₁ and may set a configuration flag that indicates that its USID has been configured. Subsequent address configuration commands are ignored by subordinate device 1014₁ based on the setting of the configuration flag or the operation of the switch 1018₁. Address configuration continues until the USID of the last subordinate device 1014_{M} in the first daisy chain has been configured.

Address configuration for the 2-wire subordinate devices 1004₀-1004_{N} and the 1-wire subordinate devices 1014₀-1014_{N} may be performed sequentially or may be interleaved. In one example, the 2-wire subordinate devices 1004₀-1004_{N} are configured before or after the 1-wire subordinate devices 1014₀-1014_{N} are configured such that there is no overlap of the address configuration procedures. In another example, the 2-wire subordinate devices 1004₀-1004_{N} and the 1-wire subordinate devices 1014₀-1014_{N} are configured concurrently, whereby some 2-wire address configuration commands may be interleaved with some 1-wire address configuration commands.

The shared PID signal 1010 may be asserted when address configuration is performed for either the 2-wire subordinate devices 1004₀-1004_{N} or for the 1-wire subordinate devices 1014₀-1014_{N}. In one example, the PID signal 1010 is asserted when it is in a high signaling state and unasserted when in a low signaling state, where the high signaling state is identifiable by a higher voltage level than the low signaling state. In another example, the PID signal 1010 is asserted when it is in a low signaling state and unasserted when in a high signaling state, where the low signaling state is identifiable by a lower voltage level than the high signaling state.

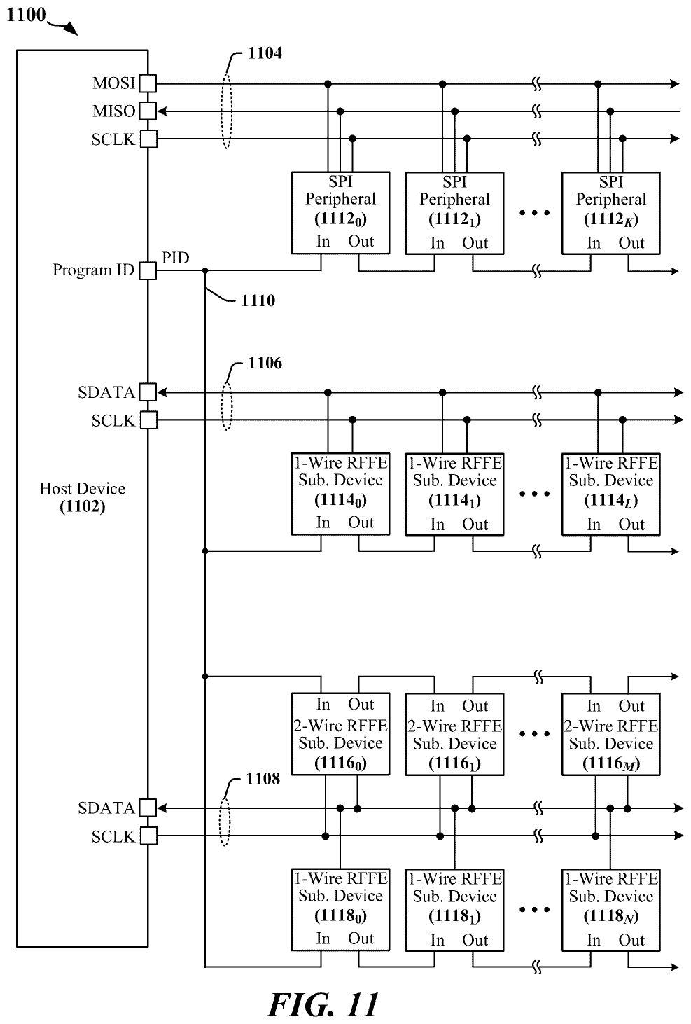

FIG. 11 illustrates a system 1100 in which a host device 1102 is the designated or configured BoM for different types of multidrop serial buses 1104, 1106, 1108. The host device 1102 is the designated or configured BoM for two multidrop serial buses 1106, 1108 that are operated independently and in accordance with RFFE protocols and including a multidrop serial bus 1108 that supports 2-wire subordinate devices 1116₀-1116_{M} and 1-wire subordinate devices 1118₀-1118_{N}. The host device 1102 is also the designated bus master for a multidrop serial bus 1104 that is operated in accordance with SPI protocols.

The multidrop serial bus 1108 that supports 2-wire subordinate devices 1116₀-1116_{M} and one-wire subordinate devices 1118₀-1118_{N} corresponds to the multidrop serial bus 1006 illustrated in FIG. 10 and address configuration for the 2-wire subordinate devices 1116₀-1116_{M} and 1-wire subordinate devices 1118₀-1118_{N} may follow the procedures described in relation to FIG. 10. The host device may configure the 2-wire subordinate devices 1114₀-1114_{L} concurrently with or independently of the 2-wire subordinate devices 1116₀-1116_{M} and 1-wire subordinate devices 1118₀-1118_{N} coupled to multidrop serial bus 1108, consistent with the address configuration procedures described in relation to FIG. 9.

The procedures for configuring USID addresses on multidrop serial buses described in FIGS. 8-10 may be applied to the configuration of USIDs for the SPI peripheral devices 1112₀-1112_{K} coupled to multidrop serial bus 1104. That is, the daisy chained PID signal 1110 may be used with SPI broadcast commands transmitted over multidrop serial bus 1104 to facilitate configuration of the SPI peripheral devices 1112₀-1112_{K}. The SPI PHY circuit in the host device 1102 does not provided slave select signals to control communication, but relies on the use of USIDs that are configured in accordance with certain aspects of this disclosure. The host device 1102 uses a single I/O pin to provide PID signal 1110 and the SPI peripheral devices 1112₀-1112_{K} may be implemented with an input I/O pin that receives the PID signal 1110 and an output I/O pin that forwards the PID signal 1110. The input I/O pin and output I/O pin are coupled through a switch that is operated in accordance with certain aspects of this disclosure (see, e.g., FIG. 8). The same PID signal 1110 is used during the configuration of the 2-wire subordinate devices 1114₀-1114_{L}, 1116₀-1116_{M} and 1-wire subordinate devices 1118₀-1118_{N} that are coupled to RFFE multidrop serial buses 1106 or 1108 as well as the SPI peripheral devices 1112₀-1112_{K} coupled to multidrop serial bus 1104.

In some subsystems existing architectural features may be adapted to support dynamic address configuration in accordance with certain aspects of this disclosure. In one example, a power management integrated circuit (PMIC) can be used to manage power within a system that has multiple functional elements provided by a variety of IC devices that are powered using multiple power domains. A PMIC may be coupled to an SoC using a high-speed serial bus operated in accordance with SPMI protocols. In more complex systems, multiple PMICs may be used to manage the power grid that supports some combination of SOCs, modems, application processors, display subsystems, camera subsystems and the like. Multiple instances of the same type of PMIC may be deployed within the system, where each PMIC or a small number of PMICs are coupled through one of several SPMI interfaces. Fault indications can be communicated in certain conventional PMICs using a fault indication signal that is daisy-chained between PMICs. According to certain aspects of this disclosure, a PMIC may be adapted to support dynamic address configuration using a common SPMI bus and a modified fault indication daisy-chain.

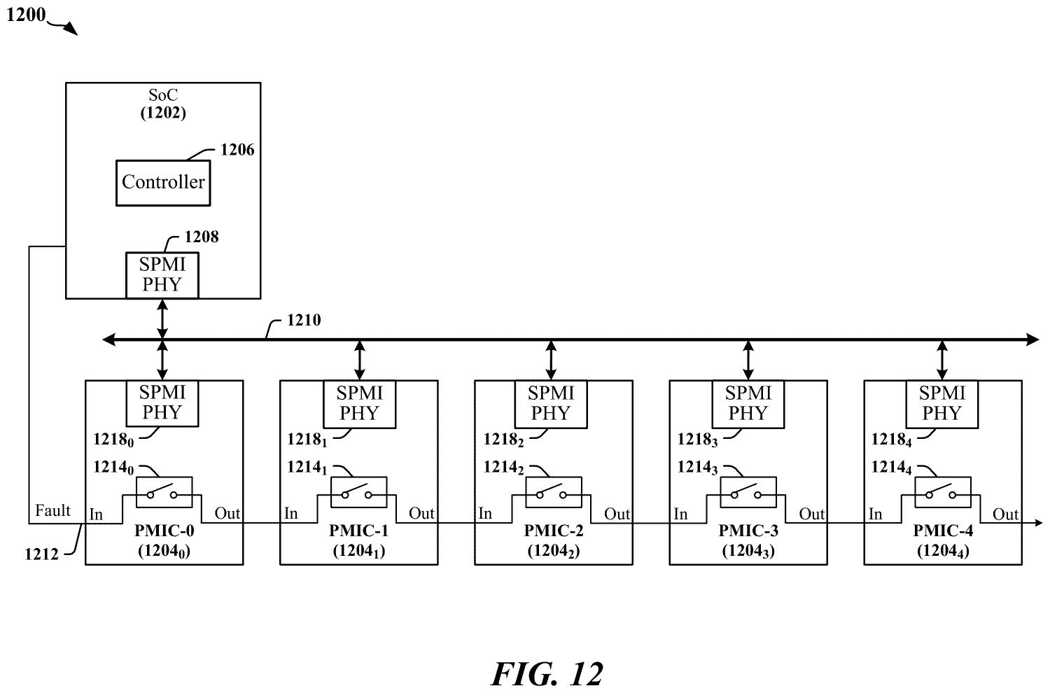

FIG. 12 illustrates an example of a system 1200 that includes one SoC 1202 and multiple PMICs 1204₀, 1204₁, 1204₂, 1204₃, 1204₄. Other SOCs, modems, application processors, subsystems and peripherals coupled to or managed by the PMICs 1204₀, 1204₁, 1204₂, 1204₃, 1204₄ are omitted from the drawing for the sake of clarity. The PMICs 1204₀, 1204₁, 1204₂, 1204₃, 1204₄ may use multiple instances of the same type of PMIC to manage power distribution, administer budgets and monitor power usage. The PMICs 1204₀, 1204₁, 1204₂, 1204₃, 1204₄ may be communicatively coupled through a high-speed serial bus 1210. In the illustrated example, the high-speed serial bus 1210 is implemented in accordance with SPMI protocols defined by the MIPI Alliance. SPMI protocols may be optimized for the real-time control of one or more devices including the PMICs 1204₀, 1204₁, 1204₂, 1204₃, 1204₄.

The high-speed serial bus 1210 may additionally couple the SoC 1202 and other devices and/or subsystems to the PMICs 1204₀, 1204₁, 1204₂, 1204₃, 1204₄. The SoC 1202 is coupled to the high-speed serial bus 1210 through SPMI physical layer circuits (the SPMI PHY 1208) and the PMICs 1204₀, 1204₁, 1204₂, 1204₃, 1204₄ are coupled to the high-speed serial bus 1210 through corresponding SPMI physical layer circuits (the SPMI PHY 1218₀-1218₄). In some examples, the SPMI PHY 1208 in the SoC 1202 may be configured to operate as a BoM for the high-speed serial bus 1210. The SoC 1202 operating as a BoM can be configured to manage and control operations on the high-speed serial bus 1210. The combination of the high-speed serial bus 1210 and SPMI protocols enables the high-speed serial bus 1210 to be operated as a shared bus that provides for high-speed, low-latency connection for a variety of devices or device types and enables data transmissions to be managed according to priorities assigned to different traffic classes.

A fault signaling circuit in each of the PMICs 1204₀, 1204₁, 1204₂, 1204₃, 1204₄ may be modified by the addition of a switch 1214₀, 1214₁, 1214₂, 1214₃, 1214₄ that can be used to interrupt a fault indication signal 1212 that is daisy-chained between the PMICs 1204₀, 1204₁, 1204₂, 1204₃, 1204₄. In normal operation, the switches 1214₀, 1214₁, 1214₂, 1214₃, 1214₄ are closed and the fault indication signal 1212 can flow unimpeded between the PMICs 1204₀, 1204₁, 1204₂, 1204₃, 1204₄. The fault indication signal 1212 is used by all PMICs 1204₀, 1204₁, 1204₂, 1204₃, 1204₄ and is used to indicate occurrence of a fault condition in one PMIC 1204₀, 1204₁, 1204₂, 1204₃ or 1204₄ to all of the other PMICs 1204₀, 1204₁, 1204₂, 1204₃ and/or 1204₄. The fault indication signal 1212 is not used during system configuration.

During system configuration, the switches 1214₀, 1214₁, 1214₂, 1214₃, 1214₄ are opened to facilitate address configuration procedures conducted in accordance with certain aspects of this disclosure. A controller 1206 in the SoC 1202 is configured to cause the fault indication signal 1212 to be asserted at the input to the first PMIC 1204₀ during address configuration. The fault indication signal 1212 may be asserted when the controller activates the output of a line driver that is in a high impedance during normal operations. The fault indication signal 1212 serves as a program enable signal during dynamic address configuration. The controller 1206 initiates dynamic address configuration by transmitting an initial broadcast command over the high-speed serial bus 1210. By protocol, all PMICs 1204₀-1204₄ coupled to the high-speed serial bus 1210 respond to the initial broadcast command without reference to their internal USIDs. The initial SPMI broadcast command is a write command that does not require communicative response from any PMIC 1204₀-1204₄. Two or more of the PMICs 1204₀-1204₄ programmed with the same USID can respond to the initial broadcast command without interfering with one another.

According to an aspect of this disclosure, the initial broadcast command causes each of the PMICs 1204₀-1204₄ to open their respective switches 1214₀-1214₄ and to enter a device address configuration mode of operation. In some examples, each PMIC 1204₀-1204₄ may set a flag to indicate that device address configuration is in progress. The controller 1206 may configure the USIDs of the PMIC 1204₀-1204₄ by transmitting a series of address configuration commands. Each address configuration command is a broadcast command that produces a response in one of the PMICs 1204₀-1204₄. In some implementations, the controller 1206 transmits USIDs in the address configuration commands in an order that corresponds to the position of PMICs 1204₀-1204₄ in the daisy chain. For example, the first address configuration command is configured with the USID for the first PMIC 1204₀ in the daisy chain that receives the fault indication signal 1212 directly from the SoC 1202. The first address configuration command causes the USID to be written to a register in the first PMIC 1204₀ in the daisy chain.

Each PMIC 1204₀-1204₄ is configured to respond to the next address configuration command transmitted over the high-speed serial bus 1210 after detecting that the fault indication signal 1212 is asserted. The PMIC 1204₀-1204₄ may detect assertion of the fault indication signal 1212 by sensing the state of its fault input. The fault indication signal 1212 initially drives only the fault input of PMIC 1204₀ after all switches 1214₀-1214₄ have been opened. The USID of PMIC 1204₀ is configured in response to the first-transmitted address configuration command. Upon writing its USID, PMIC 1204₀ closes its switch 1214₀ and may set a configuration flag that indicates that its USID has been configured. Subsequent address configuration commands are ignored by PMIC 1204₀ based on the setting of the configuration flag. The closing of the switch 1214₀ in PMIC 1204₀ extends the daisy chain to the next device, which is PMIC 1204₁. PMIC 1204₁ then senses that the fault indication signal 1212 is asserted and the USID of PMIC 1204₁ is configured in response to the next-transmitted address configuration command. Upon writing its USID, PMIC 1204₁ closes its switch 1214₁ and may set a configuration flag that indicates that its USID has been configured. Subsequent address configuration commands may be ignored by PMIC 1204₁ based on the setting of the configuration flag or the operation of the switch 1214₁. In some implementations, subsequent commands related to address configuration may also be ignored because address fields in the ignored commands do not match the USID of one or more of the PMICs 1204₀-1204₄. Address configuration continues until the USID of the last PMIC 1204₄ in the daisy chain has been configured.

In some implementations, the controller 1206 in the SoC 1202 may cause a broadcast command to be transmitted over the high-speed serial bus 1210 in order to cause the PMICs 1204₀-1204₄ to terminate or exit the device address configuration mode of operation. In some implementations, the SoC 1202 may interrogate a PMIC 1204₀-1204₄ after configuring its USID. The SoC 1202 may transmit a read command to cause a PMIC 1204₀-1204₄ to read back its newly configured USID. In some instances, only the most-recently configured PMIC 1204₀-1204₄ processes the read command during address configuration mode of operation and the SoC 1202 may subsequently transmit a write command to cause the recently configured PMIC 1204₀-1204₄ to close its switch 1214₀-1214₄ and/or set the configuration flag that indicates that its USID has been configured.

When USIDs have been configured in all PMICs 1204₀-1204₄, all 1214₀-1214₄ are expected to have been closed and the fault indication signal 1212 may be used for fault indication purposes. According to an aspect of this disclosure, the controller 1206 may send a terminating broadcast command that causes each of the PMICs 1204₀-1204₄ to close their respective switches 1214₀-1214₄ and to exit the device address configuration mode of operation.

According to certain aspects of this disclosure, provision may be made for the disclosed address configuration procedures to be modified when a fault occurs in one or more subordinate devices (or PMICs) that would otherwise prevent USID configuration for all devices. With reference to the example illustrated in FIG. 8, for example, a failure of subordinate device 804₁ to participate in the address configuration procedure could prevent configuration of USIDs for subordinate device 804₁-804₁. In some implementations, address configuration may be performed when this type of fault occurs by using a second daisy chain or by executing the address configuration in reverse order. In the example in which subordinate device 804₁ does not participate, the address configuration may be completed by resuming the procedure with the configuration of subordinate device 804₁. The reverse procedure may require that the subordinate devices are configured with bidirectional drivers and switches.

### Examples of Processing Circuits and Methods

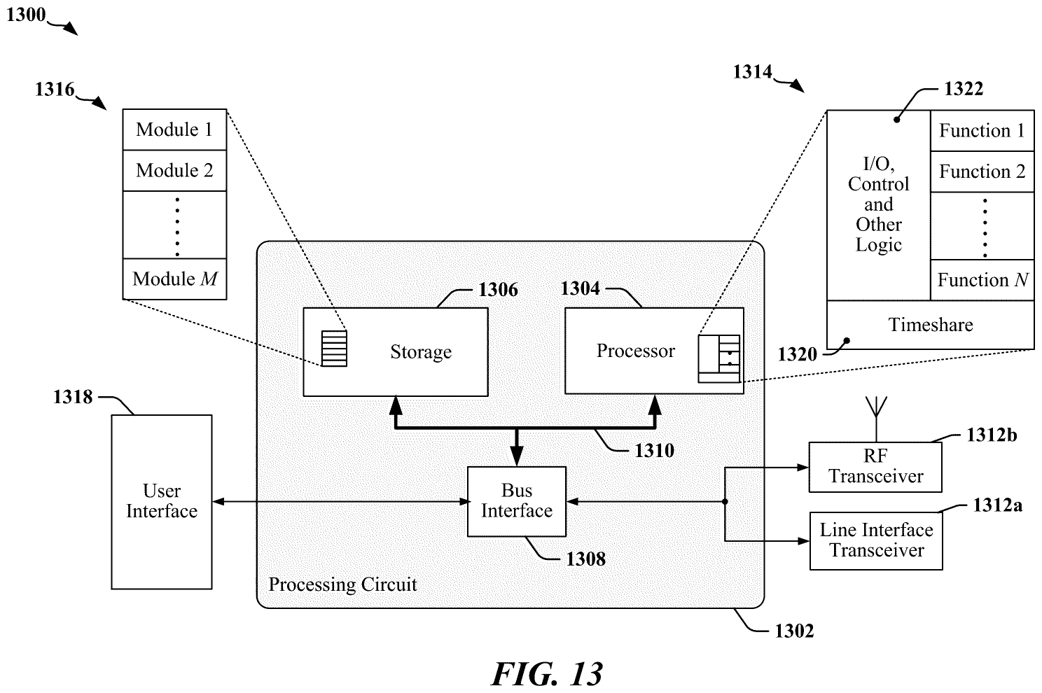

FIG. 13 is a diagram illustrating an example of a hardware implementation for an apparatus 1300. In some examples, the apparatus 1300 may perform one or more functions disclosed herein. In accordance with various aspects of the disclosure, an element, or any portion of an element, or any combination of elements as disclosed herein may be implemented using a processing circuit 1302. The processing circuit 1302 may include one or more processors 1304 that are controlled by some combination of hardware and software modules. Examples of processors 1304 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1304 may include specialized processors that perform specific functions, and that may be configured, augmented or controlled by one of the software modules 1316. The one or more processors 1304 may be configured through a combination of software modules 1316 loaded during initialization, and further configured by loading or unloading one or more software modules 1316 during operation.

In the illustrated example, the processing circuit 1302 may be implemented with a bus architecture, represented generally by the bus 1310. The bus 1310 may include any number of interconnecting buses and bridges depending on the specific application of the processing circuit 1302 and the overall design constraints. The bus 1310 links together various circuits including the one or more processors 1304, and storage 1306. Storage 1306 may include memory devices and mass storage devices, and may be referred to herein as computer-readable media and/or processor-readable media. The bus 1310 may also link various other circuits such as timing sources, timers, peripherals, voltage regulators, and power management circuits. A bus interface 1308 may provide an interface between the bus 1310 and one or more transceivers 1312a, 1312b. A transceiver 1312a, 1312b may be provided for each networking technology supported by the processing circuit. In some instances, multiple networking technologies may share some or all of the circuitry or processing modules found in a transceiver 1312a, 1312b. Each transceiver 1312a, 1312b provides a means for communicating with various other apparatus over a transmission medium. In one example, a transceiver 1312a may be used to couple the apparatus 1300 to a multi-wire bus. In another example, a transceiver 1312b may be used to connect the apparatus 1300 to a radio access network. Depending upon the nature of the apparatus 1300, a user interface 1318 (e.g., keypad, display, speaker, microphone, joystick) may also be provided, and may be communicatively coupled to the bus 1310 directly or through the bus interface 1308.

A processor 1304 may be responsible for managing the bus 1310 and for general processing that may include the execution of software stored in a computer-readable medium that may include the storage 1306. In this respect, the processing circuit 1302, including the processor 1304, may be used to implement any of the methods, functions and techniques disclosed herein. The storage 1306 may be used for storing data that is manipulated by the processor 1304 when executing software, and the software may be configured to implement any one of the methods disclosed herein.

One or more processors 1304 in the processing circuit 1302 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1306 or in an external computer-readable medium. The external computer-readable medium and/or storage 1306 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1306 may also include, by way of example, a carrier wave, a transmission line, and any other suitable medium for transmitting software and/or instructions that may be accessed and read by a computer. Computer-readable medium and/or the storage 1306 may reside in the processing circuit 1302, in the processor 1304, external to the processing circuit 1302, or be distributed across multiple entities including the processing circuit 1302. The computer-readable medium and/or storage 1306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1306 may maintain software maintained and/or organized in loadable code segments, modules, applications, programs, etc., which may be referred to herein as software modules 1316. Each of the software modules 1316 may include instructions and data that, when installed or loaded on the processing circuit 1302 and executed by the one or more processors 1304, contribute to a run-time image 1314 that controls the operation of the one or more processors 1304. When executed, certain instructions may cause the processing circuit 1302 to perform functions in accordance with certain methods, algorithms and processes described herein.

Some of the software modules 1316 may be loaded during initialization of the processing circuit 1302, and these software modules 1316 may configure the processing circuit 1302 to enable performance of the various functions disclosed herein. For example, some software modules 1316 may configure internal devices and/or logic circuits 1322 of the processor 1304, and may manage access to external devices such as a transceiver 1312a, 1312b, the bus interface 1308, the user interface 1318, timers, mathematical coprocessors, and so on. The software modules 1316 may include a control program and/or an operating system that interacts with interrupt handlers and device drivers, and that controls access to various resources provided by the processing circuit 1302. The resources may include memory, processing time, access to a transceiver 1312a, 1312b, the user interface 1318, and so on.

One or more processors 1304 of the processing circuit 1302 may be multifunctional, whereby some of the software modules 1316 are loaded and configured to perform different functions or different instances of the same function. The one or more processors 1304 may additionally be adapted to manage background tasks initiated in response to inputs from the user interface 1318, the transceiver 1312a, 1312b, and device drivers, for example. To support the performance of multiple functions, the one or more processors 1304 may be configured to provide a multitasking environment, whereby each of a plurality of functions is implemented as a set of tasks serviced by the one or more processors 1304 as needed or desired. In one example, the multitasking environment may be implemented using a timesharing program 1320 that passes control of a processor 1304 between different tasks, whereby each task returns control of the one or more processors 1304 to the timesharing program 1320 upon completion of any outstanding operations and/or in response to an input such as an interrupt. When a task has control of the one or more processors 1304, the processing circuit is effectively specialized for the purposes addressed by the function associated with the controlling task. The timesharing program 1320 may include an operating system, a main loop that transfers control on a round-robin basis, a function that allocates control of the one or more processors 1304 in accordance with a prioritization of the functions, and/or an interrupt driven main loop that responds to external events by providing control of the one or more processors 1304 to a handling function.

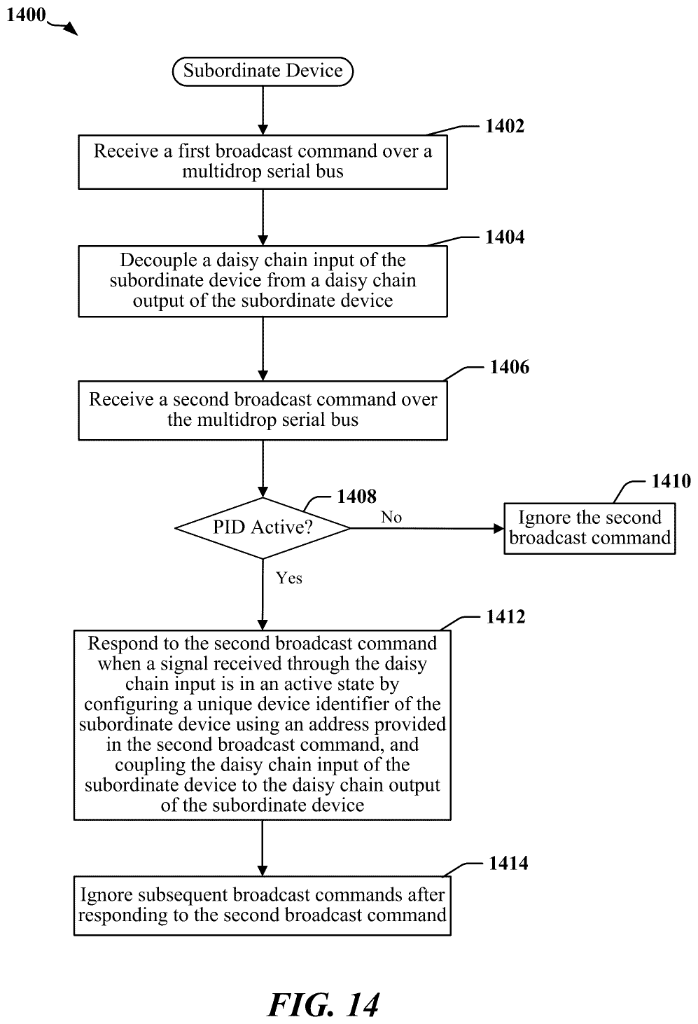

FIG. 14 is a flowchart 1400 of a method that may be performed at a subordinate device coupled to a multidrop serial bus when the subordinate device participates in address assignment through iterative communication with a host device. The subordinate device may include a controller and a switch. At block 1402, the controller may receive a first broadcast command over a multidrop serial bus. At block 1404, the controller may decouple a daisy chain input of the subordinate device from a daisy chain output of the subordinate device. At block 1406, the controller may receive a second broadcast command over the multidrop serial bus. At block 1408, the controller may determine whether the signal received through the daisy chain input is in an active state. If the signal received through the daisy chain input is in an inactive state, then at block 1410, the controller ignores the second broadcast command and may wait for additional broadcast commands until the daisy chain input is in an active state. If the signal received through the daisy chain input is in an active state, then at block 1412 the controller may respond to the second broadcast command. Responding to the second broadcast command may include configuring a unique device identifier of the subordinate device using an address provided in the second broadcast command, and coupling the daisy chain input of the subordinate device to the daisy chain output of the subordinate device. At block 1414, the controller may ignore subsequent broadcast commands after responding to the second broadcast command.

In some examples, decoupling the daisy chain input of the subordinate device to the daisy chain output of the subordinate device includes opening a switch that couples the daisy chain input of the subordinate device and the daisy chain output of the subordinate device. Coupling the daisy chain input of the subordinate device to the daisy chain output of the subordinate device may include closing the switch in the subordinate device.

In certain examples, multidrop serial bus is operated in accordance with an RFFE protocol defined by the MIPI Alliance. The first broadcast command and the second broadcast command may be received using a single wire of the multidrop serial bus.

In some examples, the multidrop serial bus is operated in accordance with SPI protocols defined by the MIPI Alliance.

In certain implementations, the multidrop serial bus is operated in accordance with a SPMI protocol defined by the MIPI Alliance. In some implementations, the subordinate device is a PMIC. The daisy chain input of the subordinate device and the daisy chain output of the subordinate device may be configured to communicate or respond to a fault indication signal generated by one of a plurality of PMICs coupled to the multidrop serial bus.

In some implementations, the controller may set a flag indicating that the unique device identifier is configured after responding to the second broadcast command. Each subordinate device may be further configured to ignore subsequent address configuration commands when the flag is set.

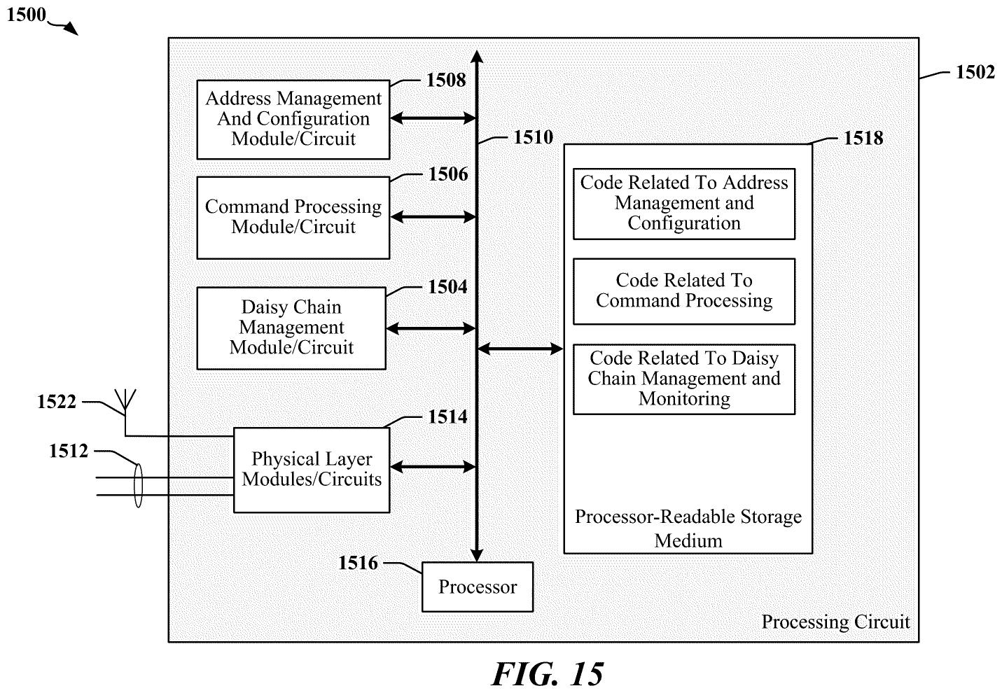

FIG. 15 is a diagram illustrating a simplified example of a hardware implementation for an apparatus 1500 employing a processing circuit 1502. The processing circuit typically has a controller or processor 1516 that may include one or more microprocessors, microcontrollers, digital signal processors, sequencers and/or state machines. The processing circuit 1502 may be implemented with a bus architecture, represented generally by the bus 1510. The bus 1510 may include any number of interconnecting buses and bridges depending on the specific application of the processing circuit 1502 and the overall design constraints. The bus 1510 links together various circuits including one or more processors and/or hardware modules, represented by the controller or processor 1516, the modules or circuits 1504, 1506 and 1508 and the processor-readable storage medium 1518. One or more physical layer circuits and/or modules 1514 may be provided to support communications over a communication link implemented using a multi-wire bus 1512, through an antenna or antenna array 1522 (to a radio access network for example), and so on. The bus 1510 may also link various other circuits such as timing sources, peripherals, voltage regulators, and power management circuits, which are well known in the art, and therefore, will not be described any further.

The processor 1516 is responsible for general processing, including the execution of software, code and/or instructions stored on the processor-readable storage medium 1518. The processor-readable storage medium may include a non-transitory storage medium. The software, when executed by the processor 1516, causes the processing circuit 1502 to perform the various functions described supra for any particular apparatus. The processor-readable storage medium may be used for storing data that is manipulated by the processor 1516 when executing software. The processing circuit 1502 further includes at least one of the modules 1504, 1506 and 1508. The modules 1504, 1506 and 1508 may be software modules running in the processor 1516, resident/stored in the processor-readable storage medium 1518, one or more hardware modules coupled to the processor 1516, or some combination thereof. The modules 1504, 1506 and 1508 may include microcontroller instructions, state machine configuration parameters, or some combination thereof.

In one configuration, the apparatus 1500 includes modules and/or circuits 1504 adapted to manage a daisy chain signal path through the apparatus 1500, modules and/or circuits 1506 adapted to receive, decode, and selectively respond to commands received over a multidrop serial bus, and modules and/or circuits 1508 adapted to manage and configure the USID to be used by the apparatus 1500 when communicating over the multidrop serial bus.

In one example, the apparatus 1500 may be configured to operate as a subordinate device that includes physical layer circuits and/or modules 1514 that implement an interface circuit adapted to couple the subordinate device to a multidrop serial bus. The subordinate device may have a controller adapted or programmed to receive a first broadcast command over a multidrop serial bus, decouple a daisy chain input of the subordinate device from a daisy chain output of the subordinate device, receive a second broadcast command over the multidrop serial bus and respond to the second broadcast command when a signal received through the daisy chain input is in an active state. The controller may be further adapted or programmed to respond to the second broadcast command by configuring a unique device identifier of the subordinate device using an address provided in the second broadcast command, and by coupling the daisy chain input of the subordinate device to the daisy chain output of the subordinate device. The controller may be further adapted or programmed to ignore subsequent broadcast commands after responding to the second broadcast command.

In certain examples, the controller is further configured to open a switch that couples the daisy chain input of the subordinate device and the daisy chain output of the subordinate device when decoupling the daisy chain input of the subordinate device to the daisy chain output of the subordinate device. The controller may be further adapted or programmed to close a switch that couples the daisy chain input of the subordinate device and the daisy chain output of the subordinate device when coupling the daisy chain input of the subordinate device to the daisy chain output of the subordinate device.

In certain examples, the multidrop serial bus may be operated in accordance with RFFE, SPMI or SPI protocols. The first subordinate device may be implemented in a PMIC. The controller may be further configured to configure the daisy chain input of the apparatus and the daisy chain output of the first subordinate device to communicate or respond to a fault indication signal generated by one of a plurality of PMICs coupled to the first multidrop serial bus.

The processor-readable storage medium 1518 may include transitory or non-transitory storage devices configured to store code, instructions and/or parameters used to implement one or more methods or procedures disclosed herein. The processor-readable storage medium 1518 may include code for receiving a first broadcast command over a multidrop serial bus, decoupling a daisy chain input of the subordinate device from a daisy chain output of the subordinate device, receiving a second broadcast command over the multidrop serial bus; responding to the second broadcast command when a signal received through the daisy chain input is in an active state, ignoring the second broadcast command when the signal received through the daisy chain input is in an inactive state, and ignoring subsequent broadcast commands after responding to the second broadcast command. Responding to the second broadcast command may include configuring a unique device identifier of the subordinate device using an address provided in the second broadcast command, and coupling the daisy chain input of the subordinate device to the daisy chain output of the subordinate device.

In some examples, decoupling the daisy chain input of the subordinate device to the daisy chain output of the subordinate device includes opening a switch that couples the daisy chain input of the subordinate device and the daisy chain output of the subordinate device. Coupling the daisy chain input of the subordinate device to the daisy chain output of the subordinate device may include closing a switch in the subordinate device.

In some implementations, the first broadcast command and the second broadcast command may be received using a single wire of the multidrop serial bus.

In certain examples, the multidrop serial bus may be operated in accordance with RFFE, SPMI or SPI protocols. The subordinate device may be a PMIC and the processor-readable storage medium 1518 may include code for configuring the daisy chain input of the subordinate device and the daisy chain output of the subordinate device to communicate or respond to a fault indication signal generated by one of a plurality of PMICs coupled to the multidrop serial bus.

In some implementations, the processor-readable storage medium 1518 includes code for setting a flag indicating that the unique device identifier is configured after responding to the second broadcast command. The processor-readable storage medium 1518 may include code for ignoring the subsequent address configuration commands when the flag is set.

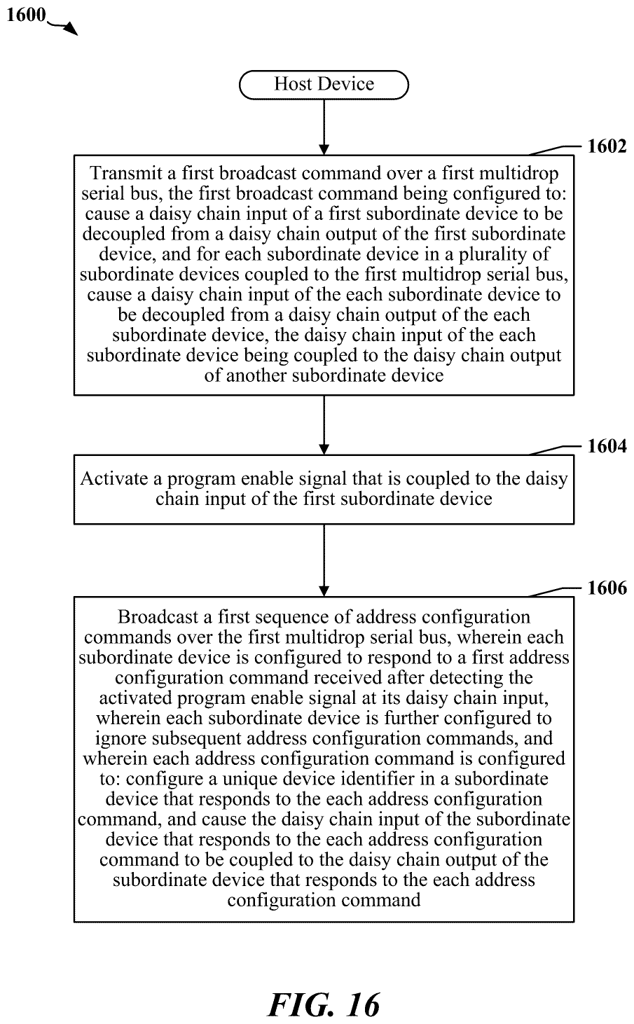

FIG. 16 is a flowchart 1600 of a method that may be performed by a host device coupled to a multidrop serial bus. The method may be used to assign device addresses through iterative communication with multiple subordinate devices that are coupled to the host device through the multidrop serial bus. In some implementations, one or more one-wire subordinate devices and one or more two-wire subordinate devices can be coupled to the multidrop serial bus.

At block 1602, the host device may transmit a first broadcast command over a first multidrop serial bus. The first broadcast command may be configured to cause a daisy chain input of a first subordinate device to be decoupled from a daisy chain output of the first subordinate device. For each subordinate device in a plurality of subordinate devices coupled to the first multidrop serial bus, the host device may cause a daisy chain input of the each subordinate device to be decoupled from a daisy chain output of the each subordinate device. The daisy chain input of the each subordinate device may be coupled to the daisy chain output of another subordinate device.

At block 1604, the host device may activate a program enable signal that is coupled to the daisy chain input of the first subordinate device.

At block 1606, the host device may broadcast a first sequence of address configuration commands over the first multidrop serial bus. Each subordinate device may be configured to respond to a first address configuration command received after detecting the activated program enable signal at its daisy chain input. Each subordinate device may be further configured to ignore subsequent address configuration commands. Each address configuration command is configured to cause the responding subordinate device to write or otherwise store a unique device identifier for the responding subordinate device. The responding subordinate device may also couple its daisy chain input to its daisy chain output.

In certain examples, the first broadcast command is configured to cause the first subordinate device to open a switch that couples the daisy chain input of the first subordinate device and the daisy chain output of the first subordinate device. The responding subordinate device may couple its daisy chain input to its daisy chain output by closing a switch in response to an address configuration command.

In certain examples, the host device may transmit a second broadcast command over a second multidrop serial bus. The second broadcast command may be configured to cause a daisy chain input of a second subordinate device to be decoupled from a daisy chain output of the second subordinate device and, for each subordinate device in a plurality of subordinate devices coupled to the second multidrop serial bus, may cause a daisy chain input of each subordinate device to be decoupled from a daisy chain output, the daisy chain input of the each subordinate device being coupled to the daisy chain output of another subordinate device. The host device may broadcast a second sequence of address configuration commands over the second multidrop serial bus. Each subordinate device may be configured to respond to a first address configuration command received after detecting the activated program enable signal at its daisy chain input. Each subordinate device may be further configured to ignore subsequent address configuration commands.

In certain examples, the host device may transmit a one-wire broadcast command using one wire of the first multidrop serial bus. In contrast, the first broadcast command is transmitted using two wires of the first multidrop serial bus. The one-wire broadcast command may be configured to cause a daisy chain input of a first one-wire subordinate device to be decoupled from a daisy chain output of the first one-wire subordinate device and for each one-wire subordinate device in a plurality of one-wire subordinate devices coupled to the first multidrop serial bus, cause a daisy chain input of the one-wire subordinate device to be decoupled from a daisy chain output of the one-wire subordinate device. The daisy chain input of each one-wire subordinate device may be coupled to the daisy chain output of another one-wire subordinate device. The host device may broadcast a sequence of one-wire address configuration commands over the first multidrop serial bus. Each one-wire subordinate device may be configured to respond to a first address one-wire configuration command received after detecting the activated program enable signal at its daisy chain input. Each one-wire subordinate device may be further configured to ignore subsequent one-wire address configuration commands.

The multidrop serial bus may be operated in accordance with RFFE protocols, SPMI protocols, SPI protocols, or other proprietary or standards-based protocols.

In one example, the first subordinate device is a PMIC and the host device may cause the PMIC to configure the daisy chain input of a first PMIC and the daisy chain output of the first PMIC to communicate or respond to a fault indication signal generated by one of a plurality of PMICs coupled to the first multidrop serial bus.

In some implementations, each subordinate device is configured to set a flag indicating that its unique device identifier has been configured after responding to the first address configuration command received after detecting the activated program enable signal at its daisy chain input. Each subordinate device may be further configured to ignore the subsequent address configuration commands when the flag is set.

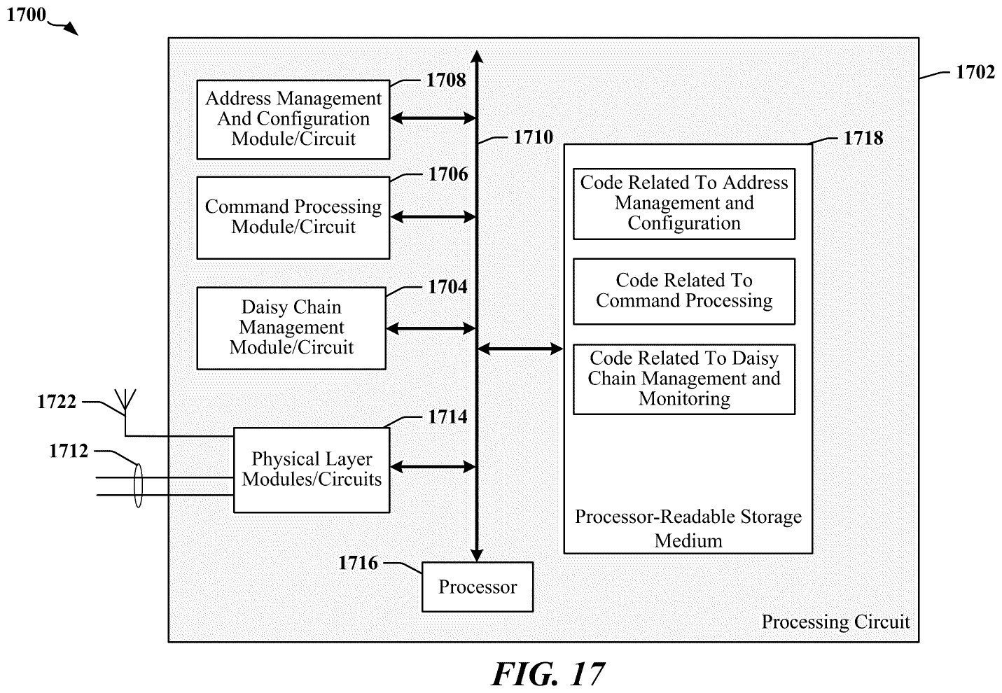

FIG. 17 is a diagram illustrating a simplified example of a hardware implementation for an apparatus 1700 employing a processing circuit 1702. The processing circuit typically has a controller or processor 1716 that may include one or more microprocessors, microcontrollers, digital signal processors, sequencers and/or state machines. The processing circuit 1702 may be implemented with a bus architecture, represented generally by the bus 1710. The bus 1710 may include any number of interconnecting buses and bridges depending on the specific application of the processing circuit 1702 and the overall design constraints. The bus 1710 links together various circuits including one or more processors and/or hardware modules, represented by the controller or processor 1716, the modules or circuits 1704, 1706 and 1708 and the processor-readable storage medium 1718. One or more physical layer circuits and/or modules 1714 may be provided to support communications over a communication link implemented using a multi-wire bus 1712, through an antenna or antenna array 1722 (to a radio access network for example), and so on. The bus 1710 may also link various other circuits such as timing sources, peripherals, voltage regulators, and power management circuits, which are well known in the art, and therefore, will not be described any further.

The processor 1716 is responsible for general processing, including the execution of software, code and/or instructions stored on the processor-readable storage medium 1718. The processor-readable storage medium may include a non-transitory storage medium. The software, when executed by the processor 1716, causes the processing circuit 1702 to perform the various functions described supra for any particular apparatus. The processor-readable storage medium may be used for storing data that is manipulated by the processor 1716 when executing software. The processing circuit 1702 further includes at least one of the modules 1704, 1706 and 1708. The modules 1704, 1706 and 1708 may be software modules running in the processor 1716, resident/stored in the processor-readable storage medium 1718, one or more hardware modules coupled to the processor 1716, or some combination thereof. The modules 1704, 1706 and 1708 may include microcontroller instructions, state machine configuration parameters, or some combination thereof.

In one configuration, the apparatus 1700 includes modules and/or circuits 1704 adapted to manage the operational mode of a daisy chain signal path through subordinate devices. The apparatus 1700 may include modules and/or circuits 1708 adapted to manage addresses associated with the subordinate devices, and modules and/or circuits 1708 adapted to generate broadcast commands used to implement and control an address management procedure in accordance with certain aspects of this disclosure.

In one example, the apparatus 1700 includes physical layer circuits and/or modules 1714 that implement an interface circuit adapted to couple the apparatus 1700 to a serial bus. The apparatus 1700 may have a controller. The processor 1716 may be configured to transmit a first broadcast command over a first multidrop serial bus, the first broadcast command being configured to cause a daisy chain input of a first subordinate device to be decoupled from a daisy chain output of the first subordinate device. The processor 1716 may be configured to cause each subordinate device in a plurality of subordinate devices coupled to the first multidrop serial bus to decouple a daisy chain input of the each subordinate device from a daisy chain output of the each subordinate device. The daisy chain input of the each subordinate device may be coupled to the daisy chain output of another subordinate device. The processor 1716 may be configured to activate a program enable signal that is coupled to the daisy chain input of the first subordinate device, and to broadcast a first sequence of address configuration commands over the first multidrop serial bus. Each subordinate device is configured to respond to a first address configuration command received after detecting the activated program enable signal at its daisy chain input. Each subordinate device may be further configured to ignore subsequent address configuration commands. Each address configuration command may be configured to configure a unique device identifier in a subordinate device that responds to the each address configuration command, and cause the daisy chain input of the subordinate device that responds to the each address configuration command to be coupled to the daisy chain output of the subordinate device that responds to the each address configuration command.

In certain implementations, the processor 1716 may be further configured to transmit a second broadcast command over a second multidrop serial bus, the second broadcast command being configured to cause a daisy chain input of a second subordinate device to be decoupled from a daisy chain output of the second subordinate device, and for each subordinate device in a plurality of subordinate devices coupled to the second multidrop serial bus, cause a daisy chain input of the each subordinate device to be decoupled from a daisy chain output of the each subordinate device. The daisy chain input of each subordinate device may be coupled to the daisy chain output of another subordinate device. The processor 1716 may be configured to broadcast a second sequence of address configuration commands over the second multidrop serial bus. Each subordinate device may be configured to respond to a first address configuration command received after detecting the activated program enable signal at its daisy chain input. Each subordinate device may be further configured to ignore subsequent address configuration commands.

In certain implementations, the processor 1716 may be configured to transmit a one-wire broadcast command using one wire of the first multidrop serial bus, whereas the first broadcast command is transmitted using two wires of the first multidrop serial bus. The one-wire broadcast command may be configured to cause a daisy chain input of a first one-wire subordinate device to be decoupled from a daisy chain output of the first one-wire subordinate device, and for each one-wire subordinate device in a plurality of one-wire subordinate devices coupled to the first multidrop serial bus, cause a daisy chain input of the each one-wire subordinate device to be decoupled from a daisy chain output of the each one-wire subordinate device. The daisy chain input of each one-wire subordinate device may be coupled to the daisy chain output of another one-wire subordinate device. The processor 1716 may be configured to broadcast a sequence of one-wire address configuration commands over the first multidrop serial bus. Each one-wire subordinate device may be configured to respond to a first address one-wire configuration command received after detecting the activated program enable signal at its daisy chain input. Each one-wire subordinate device may be further configured to ignore subsequent one-wire address configuration commands.

The multidrop serial bus may be operated in accordance with RFFE protocols, SPMI protocols, SPI protocols, or other proprietary or standards-based protocols.

In some implementations, the first subordinate device is embodied in a PMIC. The processor 1716 may be configured to configure the daisy chain input of a first subordinate device and the daisy chain output of the first subordinate device to communicate or respond to a fault indication signal generated by one of a plurality of PMICs coupled to the first multidrop serial bus.

The processor-readable storage medium 1718 may include transitory or non-transitory storage devices configured to store code, instructions and/or parameters used to implement one or more methods or procedures disclosed herein. The processor-readable storage medium 1718 may include code for transmitting a first broadcast command over a first multidrop serial bus, the first broadcast command being configured to: cause a daisy chain input of a first subordinate device to be decoupled from a daisy chain output of the first subordinate device, and for each subordinate device in a plurality of subordinate devices coupled to the first multidrop serial bus, cause a daisy chain input of the each subordinate device to be decoupled from a daisy chain output of the each subordinate device, the daisy chain input of the each subordinate device being coupled to the daisy chain output of another subordinate device. The processor-readable storage medium 1718 may include code for activating a program enable signal that is coupled to the daisy chain input of the first subordinate device and broadcasting a first sequence of address configuration commands over the first multidrop serial bus Each subordinate device may be configured to respond to a first address configuration command received after detecting the activated program enable signal at its daisy chain input. Each subordinate device may be further configured to ignore subsequent address configuration commands. Each address configuration command may be configured to configure a unique device identifier in a subordinate device that responds to the each address configuration command, and cause the daisy chain input of the subordinate device that responds to the each address configuration command to be coupled to the daisy chain output of the subordinate device that responds to the each address configuration command.

In certain examples, the first broadcast command is configured to cause the first subordinate device to open a switch that couples the daisy chain input of the first subordinate device and the daisy chain output of the first subordinate device. The daisy chain input of the subordinate device that responds to the each address configuration command is coupled to the daisy chain output of the subordinate device that responds to the each address configuration command by closing a switch in the subordinate device that responds to the each address configuration command.

The processor-readable storage medium 1718 may include code for transmitting a second broadcast command over a second multidrop serial bus. The second broadcast command may be configured to cause a daisy chain input of a second subordinate device to be decoupled from a daisy chain output of the second subordinate device, and for each subordinate device in a plurality of subordinate devices coupled to the second multidrop serial bus, cause a daisy chain input of the each subordinate device to be decoupled from a daisy chain output of the each subordinate device. The daisy chain input of each subordinate device may be coupled to the daisy chain output of another subordinate device. The processor-readable storage medium 1718 may include code for broadcasting a second sequence of address configuration commands over the second multidrop serial bus. Each subordinate device may be configured to respond to a first address configuration command received after detecting the activated program enable signal at its daisy chain input. Each subordinate device may be further configured to ignore subsequent address configuration commands.

In some implementations, the processor-readable storage medium 1718 includes code for transmitting a one-wire broadcast command using one wire of the first multidrop serial bus, whereas the first broadcast command is transmitted using two wires of the first multidrop serial bus. The one-wire broadcast command may be configured to cause a daisy chain input of a first one-wire subordinate device to be decoupled from a daisy chain output of the first one-wire subordinate device, and for each one-wire subordinate device in a plurality of one-wire subordinate devices coupled to the first multidrop serial bus, cause a daisy chain input of the each one-wire subordinate device to be decoupled from a daisy chain output of the each one-wire subordinate device. The daisy chain input of the each one-wire subordinate device may be coupled to the daisy chain output of another one-wire subordinate device. The processor-readable storage medium 1718 may include code for broadcasting a sequence of one-wire address configuration commands over the first multidrop serial bus. Each one-wire subordinate device may be configured to respond to a first address one-wire configuration command received after detecting the activated program enable signal at its daisy chain input. Each one-wire subordinate device may be further configured to ignore subsequent one-wire address configuration commands.

The first multidrop serial bus may be operated in accordance with RFFE protocols, SPMI protocols, SPI protocols, or other proprietary or standards-based protocols.

In some implementations, the first subordinate device is embodied in a PMIC. The processor 1716 may be configured to configure the daisy chain input of a first subordinate device and the daisy chain output of the first subordinate device to communicate or respond to a fault indication signal generated by one of a plurality of PMICs coupled to the first multidrop serial bus.

In some implementations, each subordinate device sets a flag indicating its unique device identifier has been configured after responding to the first address configuration command received after detecting the activated program enable signal at its daisy chain input. Each subordinate device may be further configured to ignore the subsequent address configuration commands when the flag is set.

Some implementation examples are described in the following numbered clauses:
1. A method of data communication at a subordinate device, comprising: receiving a first broadcast command over a multidrop serial bus; decoupling a daisy chain input of the subordinate device from a daisy chain output of the subordinate device; receiving a second broadcast command over the multidrop serial bus; responding to the second broadcast command when a signal received through the daisy chain input is in an active state; ignoring the second broadcast command when the signal received through the daisy chain input is in an inactive state; and ignoring subsequent broadcast commands after responding to the second broadcast command, wherein responding to the second broadcast command includes: configuring a unique device identifier of the subordinate device using an address provided in the second broadcast command, and coupling the daisy chain input of the subordinate device to the daisy chain output of the subordinate device.
2. The method as described in clause 1, wherein decoupling the daisy chain input of the subordinate device from the daisy chain output of the subordinate device includes opening a switch that couples the daisy chain input of the subordinate device and the daisy chain output of the subordinate device.
3. The method as described in clause 1 or clause 2, wherein coupling the daisy chain input of the subordinate device to the daisy chain output of the subordinate device includes closing a switch in the subordinate device.
4. The method as described in any of clauses 1-3, wherein the first broadcast command and the second broadcast command are received using a single wire of the multidrop serial bus.
5. The method as described in any of clauses 1-4, wherein the multidrop serial bus is operated in accordance with a Radio Frequency Front-End (RFFE) protocol defined by the Mobile Industry Processor Interface (MIPI) Alliance.
6. The method as described in any of clauses 1-4, wherein the multidrop serial bus is operated in accordance with a system power management interface (SPMI) protocol defined by the Mobile Industry Processor Interface (MIPI) Alliance.
7. The method as described in any of clauses 1-4, wherein the multidrop serial bus is operated in accordance with a serial peripheral interface (SPI) protocol.
8. The method as described in any of clauses 1-7, wherein the subordinate device comprises a power management integrated circuit (PMIC) and further comprising: configuring the daisy chain input of the subordinate device and the daisy chain output of the subordinate device to communicate or respond to a fault indication signal generated by one of a plurality of PMICs coupled to the multidrop serial bus.
9. The method as described in any of clauses 1-8, further comprising: setting a flag indicating that the unique device identifier is configured after responding to the second broadcast command.
10. The method as described in clause 9, further comprising: ignoring the subsequent broadcast commands when the flag is set.
11. A subordinate device, comprising: an interface circuit adapted to couple the subordinate device to a multidrop serial bus; and a controller configured to: receive a first broadcast command over the multidrop serial bus; decouple a daisy chain input of the subordinate device from a daisy chain output of the subordinate device; receive a second broadcast command over the multidrop serial bus; respond to the second broadcast command when a signal received through the daisy chain input is in an active state by: configuring a unique device identifier of the subordinate device using an address provided in the second broadcast command, and coupling the daisy chain input of the subordinate device to the daisy chain output of the subordinate device; and ignore subsequent broadcast commands after responding to the second broadcast command.
12. The subordinate device as described in clause 11, wherein the controller is further configured to: open a switch that couples the daisy chain input of the subordinate device and the daisy chain output of the subordinate device when decoupling the daisy chain input of the subordinate device from the daisy chain output of the subordinate device.
13. The subordinate device as described in clause 11 or clause 12, wherein the controller is further configured to: close a switch that couples the daisy chain input of the subordinate device and the daisy chain output of the subordinate device when coupling the daisy chain input of the subordinate device to the daisy chain output of the subordinate device.
14. The subordinate device as described in any of clauses 11-13, wherein the multidrop serial bus is operated in accordance with a Radio Frequency Front-End (RFFE) protocol, a system power management interface (SPMI) protocol or a serial peripheral interface (SPI) protocol.
15. The subordinate device as described in any of clauses 11-14, wherein the subordinate device comprises a power management integrated circuit (PMIC) and wherein the controller is further configured to: configure the daisy chain input of the subordinate device and the daisy chain output of the subordinate device to communicate or respond to a fault indication signal generated by one of a plurality of PMICs coupled to the multidrop serial bus.
16. A data communication apparatus, comprising: an interface circuit adapted to couple the data communication apparatus to one or more multidrop serial buses; and a controller configured to: transmit a first broadcast command over a first multidrop serial bus, the first broadcast command being configured to cause a daisy chain input of a first subordinate device to be decoupled from a daisy chain output of the first subordinate device, and for each subordinate device in a plurality of subordinate devices coupled to the first multidrop serial bus, cause a daisy chain input of the each subordinate device to be decoupled from a daisy chain output of the each subordinate device, the daisy chain input of the each subordinate device being coupled to the daisy chain output of another subordinate device; activate a program enable signal that is coupled to the daisy chain input of the first subordinate device; and broadcast a first sequence of address configuration commands over the first multidrop serial bus, wherein the each subordinate device is configured to respond to a first address configuration command received after detecting the activated program enable signal at its daisy chain input, wherein the each subordinate device is further configured to ignore subsequent address configuration commands, and wherein each address configuration command is configured to configure a unique device identifier in a subordinate device that responds to the each address configuration command, and cause the daisy chain input of the subordinate device that responds to the each address configuration command to be coupled to the daisy chain output of the subordinate device that responds to the each address configuration command.
17. The data communication apparatus as described in clause 16, wherein the controller is further configured to: transmit a second broadcast command over a second multidrop serial bus, the second broadcast command being configured to: cause a daisy chain input of a second subordinate device to be decoupled from a daisy chain output of the second subordinate device, and for each subordinate device in a plurality of subordinate devices coupled to the second multidrop serial bus, cause a daisy chain input of the each subordinate device to be decoupled from a daisy chain output of the each subordinate device, the daisy chain input of the each subordinate device being coupled to the daisy chain output of another subordinate device; and broadcast a second sequence of address configuration commands over the second multidrop serial bus, wherein the each subordinate device is configured to respond to a first address configuration command received after detecting the activated program enable signal at its daisy chain input, and wherein the each subordinate device is further configured to ignore subsequent address configuration commands.
18. The data communication apparatus as described in clause 16 or clause 17, wherein the controller is further configured to: transmit a one-wire broadcast command using one wire of the first multidrop serial bus, wherein the first broadcast command is transmitted using two wires of the first multidrop serial bus, the one-wire broadcast command being configured to: cause a daisy chain input of a first one-wire subordinate device to be decoupled from a daisy chain output of the first one-wire subordinate device, and for each one-wire subordinate device in a plurality of one-wire subordinate devices coupled to the first multidrop serial bus, cause a daisy chain input of the each one-wire subordinate device to be decoupled from a daisy chain output of the each one-wire subordinate device, the daisy chain input of the each one-wire subordinate device being coupled to the daisy chain output of another one-wire subordinate device; and broadcast a sequence of one-wire address configuration commands over the first multidrop serial bus, wherein the each one-wire subordinate device is configured to respond to a first one-wire address configuration command received after detecting the activated program enable signal at its daisy chain input, and wherein the each one-wire subordinate device is further configured to ignore subsequent one-wire address configuration commands.
19. The data communication apparatus as described in any of clauses 16-18, wherein the first multidrop serial bus is operated in accordance with a Radio Frequency Front-End (RFFE) protocol, a system power management interface (SPMI) protocol or a serial peripheral interface (SPI) protocol.
20. The data communication apparatus as described in any of clauses 16-19, wherein the first subordinate device comprises a power management integrated circuit (PMIC) and wherein the controller is further configured to: configure the daisy chain input of the first subordinate device and the daisy chain output of the first subordinate device to communicate or respond to a fault indication signal generated by one of a plurality of PMICs coupled to the first multidrop serial bus.
21. A method of data communication at a host device, comprising: transmitting a first broadcast command over a first multidrop serial bus, the first broadcast command being configured to: cause a daisy chain input of a first subordinate device to be decoupled from a daisy chain output of the first subordinate device, and for each subordinate device in a plurality of subordinate devices coupled to the first multidrop serial bus, cause a daisy chain input of the each subordinate device to be decoupled from a daisy chain output of the each subordinate device, the daisy chain input of the each subordinate device being coupled to the daisy chain output of another subordinate device; activating a program enable signal that is coupled to the daisy chain input of the first subordinate device; and broadcasting a first sequence of address configuration commands over the first multidrop serial bus, wherein the each subordinate device is configured to respond to a first address configuration command received after detecting the activated program enable signal at its daisy chain input, wherein the each subordinate device is further configured to ignore subsequent address configuration commands, and wherein each address configuration command is configured to: configure a unique device identifier in a subordinate device that responds to the each address configuration command, and cause the daisy chain input of the subordinate device that responds to the each address configuration command to be coupled to the daisy chain output of the subordinate device that responds to the each address configuration command.
22. The method as described in clause 21, wherein the first broadcast command is configured to cause the first subordinate device to open a switch that couples the daisy chain input of the first subordinate device and the daisy chain output of the first subordinate device.
23. The method as described in clause 21 or clause 22, wherein the daisy chain input of the subordinate device that responds to the each address configuration command is coupled to the daisy chain output of the subordinate device that responds to the each address configuration command by closing a switch in the subordinate device that responds to the each address configuration command.
24. The method as described in any of clauses 21-23, further comprising: transmitting a second broadcast command over a second multidrop serial bus, the second broadcast command being configured to: cause a daisy chain input of a second subordinate device to be decoupled from a daisy chain output of the second subordinate device, and for each subordinate device in a plurality of subordinate devices coupled to the second multidrop serial bus, cause a daisy chain input of the each subordinate device to be decoupled from a daisy chain output of the each subordinate device, the daisy chain input of the each subordinate device being coupled to the daisy chain output of another subordinate device; and broadcasting a second sequence of address configuration commands over the second multidrop serial bus, wherein the each subordinate device is configured to respond to a first address configuration command received after detecting the activated program enable signal at its daisy chain input, and wherein the each subordinate device is further configured to ignore subsequent address configuration commands.
25. The method as described in any of clauses 21-24, further comprising: transmitting a one-wire broadcast command using one wire of the first multidrop serial bus, wherein the first broadcast command is transmitted using two wires of the first multidrop serial bus, the one-wire broadcast command being configured to: cause a daisy chain input of a first one-wire subordinate device to be decoupled from a daisy chain output of the first one-wire subordinate device, and for each one-wire subordinate device in a plurality of one-wire subordinate devices coupled to the first multidrop serial bus, cause a daisy chain input of the each one-wire subordinate device to be decoupled from a daisy chain output of the each one-wire subordinate device, the daisy chain input of the each one-wire subordinate device being coupled to the daisy chain output of another one-wire subordinate device; and broadcasting a sequence of one-wire address configuration commands over the first multidrop serial bus, wherein the each one-wire subordinate device is configured to respond to a first one-wire address configuration command received after detecting the activated program enable signal at its daisy chain input, and wherein the each one-wire subordinate device is further configured to ignore subsequent one-wire address configuration commands.
26. The method as described in any of clauses 21-25, wherein the first multidrop serial bus is operated in accordance with a Radio Frequency Front-End (RFFE) protocol defined by the Mobile Industry Processor Interface (MIPI) Alliance.
27. The method as described in any of clauses 21-25, wherein the first multidrop serial bus is operated in accordance with a system power management interface (SPMI) protocol defined by the Mobile Industry Processor Interface (MIPI) Alliance.
28. The method as described in any of clauses 21-25, wherein the first multidrop serial bus is operated in accordance with a serial peripheral interface (SPI) protocol.
29. The method as described in any of clauses 21-28, wherein the first subordinate device comprises a power management integrated circuit (PMIC) and further comprising: causing the PMIC to configure the daisy chain input of the first subordinate device and the daisy chain output of the first subordinate device to communicate or respond to a fault indication signal generated by one of a plurality of PMICs coupled to the first multidrop serial bus.
30. The method as described in any of clauses 21-29, wherein the each subordinate device sets a flag indicating its unique device identifier is configured after responding to the first address configuration command received after detecting the activated program enable signal at its daisy chain input, and wherein the each subordinate device is further configured to ignore the subsequent address configuration commands when the flag is set.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of data communication at a subordinate device, comprising:
receiving a first broadcast command over a multidrop serial bus;
decoupling a daisy chain input of the subordinate device from a daisy chain output of the subordinate device;
receiving a second broadcast command over the multidrop serial bus;
responding to the second broadcast command when a signal received through the daisy chain input is in an active state;
ignoring the second broadcast command when the signal received through the daisy chain input is in an inactive state; and
ignoring subsequent broadcast commands after responding to the second broadcast command,
wherein responding to the second broadcast command includes:
configuring a unique device identifier of the subordinate device using an address provided in the second broadcast command, and
coupling the daisy chain input of the subordinate device to the daisy chain output of the subordinate device.

2. The method of claim 1, wherein decoupling the daisy chain input of the subordinate device from the daisy chain output of the subordinate device includes opening a switch that couples the daisy chain input of the subordinate device and the daisy chain output of the subordinate device.

3. The method of claim 1, wherein coupling the daisy chain input of the subordinate device to the daisy chain output of the subordinate device includes closing a switch in the subordinate device.

4. The method of claim 1, wherein the first broadcast command and the second broadcast command are received using a single wire of the multidrop serial bus.

5. The method of claim 1, wherein the multidrop serial bus is operated in accordance with a Radio Frequency Front-End (RFFE) protocol defined by the Mobile Industry Processor Interface (MIPI) Alliance.

6. The method of claim 1, wherein the multidrop serial bus is operated in accordance with a system power management interface (SPMI) protocol defined by the Mobile Industry Processor Interface (MIPI) Alliance.

7. The method of claim 1, wherein the multidrop serial bus is operated in accordance with a serial peripheral interface (SPI) protocol.

8. The method of claim 1, wherein the subordinate device comprises a power management integrated circuit (PMIC) and further comprising:
configuring the daisy chain input of the subordinate device and the daisy chain output of the subordinate device to communicate or respond to a fault indication signal generated by one of a plurality of PMICs coupled to the multidrop serial bus.

9. The method of claim 1, further comprising:
setting a flag indicating that the unique device identifier is configured after responding to the second broadcast command.

10. The method of claim 9, further comprising:
ignoring the subsequent broadcast commands when the flag is set.

11. A subordinate device, comprising:
an interface circuit adapted to couple the subordinate device to a multidrop serial bus; and
a controller configured to:
receive a first broadcast command over the multidrop serial bus;
decouple a daisy chain input of the subordinate device from a daisy chain output of the subordinate device;
receive a second broadcast command over the multidrop serial bus;
respond to the second broadcast command when a signal received through the daisy chain input is in an active state by:
configuring a unique device identifier of the subordinate device using an address provided in the second broadcast command, and
coupling the daisy chain input of the subordinate device to the daisy chain output of the subordinate device; and
ignore subsequent broadcast commands after responding to the second broadcast command.

12. The subordinate device of claim 11, wherein the controller is further configured to:
open a switch that couples the daisy chain input of the subordinate device and the daisy chain output of the subordinate device when decoupling the daisy chain input of the subordinate device from the daisy chain output of the subordinate device.

13. The subordinate device of claim 11, wherein the controller is further configured to:
close a switch that couples the daisy chain input of the subordinate device and the daisy chain output of the subordinate device when coupling the daisy chain input of the subordinate device to the daisy chain output of the subordinate device.

14. The subordinate device of claim 11, wherein the multidrop serial bus is operated in accordance with a Radio Frequency Front-End (RFFE) protocol, a system power management interface (SPMI) protocol or a serial peripheral interface (SPI) protocol.

15. The subordinate device of claim 11, wherein the subordinate device comprises a power management integrated circuit (PMIC) and wherein the controller is further configured to:
configure the daisy chain input of the subordinate device and the daisy chain output of the subordinate device to communicate or respond to a fault indication signal generated by one of a plurality of PMICs coupled to the multidrop serial bus.

16. A data communication apparatus, comprising:
an interface circuit adapted to couple the data communication apparatus to one or more multidrop serial buses; and
a controller configured to:
transmit a first broadcast command over a first multidrop serial bus, the first broadcast command being configured to cause a daisy chain input of a first subordinate device to be decoupled from a daisy chain output of the first subordinate device, and for each subordinate device in a plurality of subordinate devices coupled to the first multidrop serial bus, cause a daisy chain input of the each subordinate device to be decoupled from a daisy chain output of the each subordinate device, the daisy chain input of the each subordinate device being coupled to the daisy chain output of another subordinate device;
activate a program enable signal that is coupled to the daisy chain input of the first subordinate device; and
broadcast a first sequence of address configuration commands over the first multidrop serial bus, wherein the each subordinate device is configured to respond to a first address configuration command received after detecting the activated program enable signal at its daisy chain input, wherein the each subordinate device is further configured to ignore subsequent address configuration commands, and wherein each address configuration command is configured to configure a unique device identifier in a subordinate device that responds to the each address configuration command, and cause the daisy chain input of the subordinate device that responds to the each address configuration command to be coupled to the daisy chain output of the subordinate device that responds to the each address configuration command.

17. The data communication apparatus of claim 16, wherein the controller is further configured to:
transmit a second broadcast command over a second multidrop serial bus, the second broadcast command being configured to:
cause a daisy chain input of a second subordinate device to be decoupled from a daisy chain output of the second subordinate device, and
for each subordinate device in a plurality of subordinate devices coupled to the second multidrop serial bus, cause a daisy chain input of the each subordinate device to be decoupled from a daisy chain output of the each subordinate device, the daisy chain input of the each subordinate device being coupled to the daisy chain output of another subordinate device; and
broadcast a second sequence of address configuration commands over the second multidrop serial bus, wherein the each subordinate device is configured to respond to a first address configuration command received after detecting the activated program enable signal at its daisy chain input, and wherein the each subordinate device is further configured to ignore subsequent address configuration commands.

18. The data communication apparatus of claim 16, wherein the controller is further configured to:
transmit a one-wire broadcast command using one wire of the first multidrop serial bus, wherein the first broadcast command is transmitted using two wires of the first multidrop serial bus, the one-wire broadcast command being configured to:
cause a daisy chain input of a first one-wire subordinate device to be decoupled from a daisy chain output of the first one-wire subordinate device, and
for each one-wire subordinate device in a plurality of one-wire subordinate devices coupled to the first multidrop serial bus, cause a daisy chain input of the each one-wire subordinate device to be decoupled from a daisy chain output of the each one-wire subordinate device, the daisy chain input of the each one-wire subordinate device being coupled to the daisy chain output of another one-wire subordinate device; and
broadcast a sequence of one-wire address configuration commands over the first multidrop serial bus, wherein the each one-wire subordinate device is configured to respond to a first one-wire address configuration command received after detecting the activated program enable signal at its daisy chain input, and wherein the each one-wire subordinate device is further configured to ignore subsequent one-wire address configuration commands.

19. The data communication apparatus of claim 16, wherein the first multidrop serial bus is operated in accordance with a Radio Frequency Front-End (RFFE) protocol, a system power management interface (SPMI) protocol or a serial peripheral interface (SPI) protocol.

20. The data communication apparatus of claim 16, wherein the first subordinate device comprises a power management integrated circuit (PMIC) and wherein the controller is further configured to:
configure the daisy chain input of the first subordinate device and the daisy chain output of the first subordinate device to communicate or respond to a fault indication signal generated by one of a plurality of PMICs coupled to the first multidrop serial bus.

21. A method of data communication at a host device, comprising:
transmitting a first broadcast command over a first multidrop serial bus, the first broadcast command being configured to:
cause a daisy chain input of a first subordinate device to be decoupled from a daisy chain output of the first subordinate device, and
for each subordinate device in a plurality of subordinate devices coupled to the first multidrop serial bus, cause a daisy chain input of the each subordinate device to be decoupled from a daisy chain output of the each subordinate device, the daisy chain input of the each subordinate device being coupled to the daisy chain output of another subordinate device;
activating a program enable signal that is coupled to the daisy chain input of the first subordinate device; and
broadcasting a first sequence of address configuration commands over the first multidrop serial bus, wherein the each subordinate device is configured to respond to a first address configuration command received after detecting the activated program enable signal at its daisy chain input, wherein the each subordinate device is further configured to ignore subsequent address configuration commands, and wherein each address configuration command is configured to:
configure a unique device identifier in a subordinate device that responds to the each address configuration command, and
cause the daisy chain input of the subordinate device that responds to the each address configuration command to be coupled to the daisy chain output of the subordinate device that responds to the each address configuration command.

22. The method of claim 21, wherein the first broadcast command is configured to cause the first subordinate device to open a switch that couples the daisy chain input of the first subordinate device and the daisy chain output of the first subordinate device.

23. The method of claim 21, wherein the daisy chain input of the subordinate device that responds to the each address configuration command is coupled to the daisy chain output of the subordinate device that responds to the each address configuration command by closing a switch in the subordinate device that responds to the each address configuration command.

24. The method of claim 21, further comprising:
transmitting a second broadcast command over a second multidrop serial bus, the second broadcast command being configured to:
cause a daisy chain input of a second subordinate device to be decoupled from a daisy chain output of the second subordinate device, and
for each subordinate device in a plurality of subordinate devices coupled to the second multidrop serial bus, cause a daisy chain input of the each subordinate device to be decoupled from a daisy chain output of the each subordinate device, the daisy chain input of the each subordinate device being coupled to the daisy chain output of another subordinate device; and
broadcasting a second sequence of address configuration commands over the second multidrop serial bus, wherein the each subordinate device is configured to respond to a first address configuration command received after detecting the activated program enable signal at its daisy chain input, and wherein the each subordinate device is further configured to ignore subsequent address configuration commands.

25. The method of claim 21, further comprising:
transmitting a one-wire broadcast command using one wire of the first multidrop serial bus, wherein the first broadcast command is transmitted using two wires of the first multidrop serial bus, the one-wire broadcast command being configured to:
cause a daisy chain input of a first one-wire subordinate device to be decoupled from a daisy chain output of the first one-wire subordinate device, and
for each one-wire subordinate device in a plurality of one-wire subordinate devices coupled to the first multidrop serial bus, cause a daisy chain input of the each one-wire subordinate device to be decoupled from a daisy chain output of the each one-wire subordinate device, the daisy chain input of the each one-wire subordinate device being coupled to the daisy chain output of another one-wire subordinate device; and
broadcasting a sequence of one-wire address configuration commands over the first multidrop serial bus, wherein the each one-wire subordinate device is configured to respond to a first one-wire address configuration command received after detecting the activated program enable signal at its daisy chain input, and wherein the each one-wire subordinate device is further configured to ignore subsequent one-wire address configuration commands.

26. The method of claim 21, wherein the first multidrop serial bus is operated in accordance with a Radio Frequency Front-End (RFFE) protocol defined by the Mobile Industry Processor Interface (MIPI) Alliance.

27. The method of claim 21, wherein the first multidrop serial bus is operated in accordance with a system power management interface (SPMI) protocol defined by the Mobile Industry Processor Interface (MIPI) Alliance.

28. The method of claim 21, wherein the first multidrop serial bus is operated in accordance with a serial peripheral interface (SPI) protocol.

29. The method of claim 21, wherein the first subordinate device comprises a power management integrated circuit (PMIC) and further comprising:
causing the PMIC to configure the daisy chain input of the first subordinate device and the daisy chain output of the first subordinate device to communicate or respond to a fault indication signal generated by one of a plurality of PMICs coupled to the first multidrop serial bus.

30. The method of claim 21, wherein the each subordinate device sets a flag indicating its unique device identifier is configured after responding to the first address configuration command received after detecting the activated program enable signal at its daisy chain input, and wherein the each subordinate device is further configured to ignore the subsequent address configuration commands when the flag is set.
